(19) United States
(12) Patent Application Publication
(10) Pub. No.: US 2026/0073911 A1
(43) Pub. Date: Mar. 12, 2026

(54) SYSTEMS FOR AND METHODS OF SPEECH DIARIZATION USING ARTIFICIAL INTELLIGENCE MODELS WITH SORTING FUNCTIONALITY

(71) Applicant: NVIDIA Corporation, Santa Clara, CA (US)

(72) Inventors: Taejin PARK, San Jose, CA (US); Kunal DHAWAN, San Jose, CA (US); Venkata Naga Krishna Chaitanya PUVVADA, San Jose, CA (US); He HUANG, Greenville, SC (US); Weiqing WANG, San Jose, CA (US); Nithin Rao KOLUGURI, Erie, PA (US); Ivan MEDENNIKOV, Prague (CZ); Jagadeesh BALAM, Campbell, CA (US); Boris GINSBURG, Sunnyvale, CA (US)

(73) Assignee: NVIDIA Corporation, Santa Clara, CA (US)

(21) Appl. No.: 18/882,293

(22) Filed: Sep. 11, 2024

(51) Int. Cl. G10L 15/16; G10L 15/26

(52) U.S. Cl. CPC G10L 15/16; G10L 15/26

(57) ABSTRACT

In various examples, multi-speaker audio is diarized using artificial intelligence models including a sorting functionality. Sorting is performed based on the first time a speaker is indicated as speaking and/or based on the variance of a dimension of a speech embedding. Sorting speech sequences has the advantage of requiring fewer computations of cross-entropy loss during training and/or allowing diarization models to focus on the difference between speakers. Diarized speech may be used to create a transcript in conjunction with automatic speech recognition models.

### BACKGROUND

Speech diarization includes the process of indicating, for each time slice in an audio recording or stream, any speaker that is talking. Speech diarization can be performed using neural network models by embedding into sequences of arrays for processing. However, complexities arise when trying to assign speech to multiple speakers. During ground truth labeling speakers can be assigned an arbitrary index (e.g., ordering) making it difficult to compare the ground truth to network outputs during training. Training methods used to overcome this problem are computationally expensive and scale very quickly with the number of speakers. For example, permutation invariant learning (PIL) or training (PIT) calculate the cross-entropy loss for each speaker permutation of the ground truth and update the model parameters based on the permutation that yields the minimum cross-entropy loss. With even a medium sized number of speakers, the number of permutations can become prohibitively large. It requires only ten speakers to create over a million permutations and thirteen to create a billion.

### SUMMARY

Implementations of the present disclosure relate to systems for and methods of speech diarization using artificial intelligence models with sorting functionality. Systems and methods are disclosed that can be used to both train the artificial intelligence model and use the artificial intelligence model to perform speech diarization. The systems and methods described herein can be used in combination with other artificial intelligence models to provide diarized transcripts of audio recordings and/or audio streams.

In contrast to conventional systems, the diarization models of the present disclosure can use a sorting functionality and a transformer-based architecture, which can facilitate more accurate diarization with lower computational resource expenditure. The transformer-based architecture can provide a simplified architecture and can allow for parallelization in training. The diarization or speaker arrays indicating which speaker is speaking at each time slice can be sorted based on the first time slice the speaker was speaking. Sorting the speaker arrays can provide various advantages over conventional systems. Calculation of the cross-entropy loss for a large number of speaker index permutations is not required as both the ground truth and the model output are sorted during training. Sorting the output of each layer can allow multiple layer outputs to be combined within a single model without using attractors or other techniques to align speaker indexing. Additionally, speakers can be naturally given the next index when they first speak; no matching of schemes are required to ensure that the outputs with the new speaker align with previous outputs.

At least one aspect of the present disclosure relates to one or more processors including processing circuitry to sort a speech sequences, representing speech from multiple speakers to generate sorted speech sequences. The one or more processors can also output speaker arrays, the speaker arrays indicating time periods for which a respective speaker associated with a speaker array is speaking, sorted speech sequences and one or more layers of a neural network model. In various implementations, the neural network model is updated based on training data including a number of example speech sequences and corresponding speaker arrays.

In various implementations, the speech sequences include intermediate speaker arrays and the processing circuitry can sort the speech sequences based on at least a time period indicated first for the intermediate speaker arrays. In various implementations, the speech sequences include a number of dimensions of a speech embedding corresponding to the speech and the processing circuitry can sort the speech sequences based on at least a variance of a dimension.

In various implementations, the processing circuitry can update the neural network model based on a comparison of an estimated output generated by the one or more layers of the neural network model using example speech sequences of the training data and speaker arrays corresponding to the example speech sequences. In various implementations, the comparison includes calculating a loss value between the estimated output and a number of order permutations of the speaker arrays corresponding to the example speech sequences.

In various implementations, the processing circuitry can generate the speech sequences as a sequence of embeddings of multiple dimensions corresponding to audio data that includes the speech from the multiple speakers. In various implementations, the one or more layers of the neural network model include layers to perform speech recognition of audio data from which the plurality of speech sequences is generated. In various implementations, the one or more layers of the neural network model includes a number of encoders and an output function, the number of encoders including at least one encoder configured to sort the speaker arrays and provide the sorted speaker arrays directly to the output function.

In various implementations, the one or more processors are included in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more multi-model language models; a system implementing one or more large language models (LLMs); a system implementing one or more vision language models (VLMs); a system for generating synthetic data; a system for generating synthetic data using AI; a system incorporating one or more virtual machines (VMs); a system implemented at least partially in a data center; or a system implemented at least partially using cloud computing resources.

At least one aspect of the present disclosure relates to a system including one or more processors. The system can calculate a loss value based on a comparison between a sorted speaker arrays generated by one or more layers of a neural network model and speaker arrays corresponding to an example speech sequence. In various implementations, the sorted speaker arrays indicate time periods for which a respective speaker associated with a speaker array of the sorted speaker arrays is speaking. In various implementations, the sorted speaker arrays are sorted based on at least a time period indicated first for the speaker array. The system can also adjust parameters of the one or more layers of the neural network model based on the loss value.

In various implementations, the system can calculate a variance of a speech sequence of the one or more layers of the neural network model and the speech sequence is removed from affecting speaker arrays generated by the neural network model based on the variance of the speech sequence. In various implementations, a plurality of loss values are calculated based on order permutations of the speaker arrays corresponding to the example speech sequence and adjusting the parameters is based on a minimum loss value.

In various implementations, the one or more layers of the neural network model include at least one encoder configured to sort speaker arrays and provide the sorted speaker arrays directly to an output function. In various implementations, providing the sorted speaker arrays directly to the output function includes bypassing a second encoder model.

In various implementations, the system is included in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more multi-model language models; a system implementing one or more large language models (LLMs); a system implementing one or more vision language models (VLMs); a system for generating synthetic data; a system for generating synthetic data using AI; a system incorporating one or more virtual machines (VMs); a system implemented at least partially in a data center; or a system implemented at least partially using cloud computing resources.

At least one aspect of the present disclosure relates to a method including generating, using one or more layers of a neural network model, speaker arrays indicating time periods for which a respective speaker associated with a speaker array is speaking. In various implementations, the one or more layers of the neural network model updated based on training data including a number of example speech sequences and corresponding speaker arrays. The method can also include sorting the plurality of speaker arrays based on at least a time period indicated first for the speaker array.

In various implementations, the method can include updating the one or more layers of the neural network model based on a comparison of an estimated output generated by the neural network model based on an example speech sequence of the training data and speaker arrays corresponding to the example speech sequence. In various implementations, the method can include calculating a loss value between the estimated output and a plurality of order permutations of the speaker arrays corresponding to the example speech sequence. In various implementations, the method can include generating a sequence of embeddings of multiple dimensions corresponding to audio data that includes the speech from a plurality of speakers and sorting the multiple dimensions of the sequence of embeddings based on a variance of the multiple dimensions.

In various implementations, the method is performed by at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more multi-model language models; a system implementing one or more large language models (LLMs); a system implementing one or more vision language models (VLMs); a system for generating synthetic data; a system for generating synthetic data using AI; a system incorporating one or more virtual machines (VMs); a system implemented at least partially in a data center; or a system implemented at least partially using cloud computing resources.

### BRIEF DESCRIPTION OF THE DRAWINGS

The present systems and methods for systems for and methods of speech diarization using artificial intelligence models with sorting functionality are described in detail below with reference to the attached drawing figures, wherein:

FIG. 1 is a block diagram of an example networked computer system for capturing audio and performing diarization of the audio recording or stream suitable for use in implementing at least some implementations of the present disclosure;

FIG. 2A is a functional block diagram of an example system for performing training of a speech diarization model using sort functionality suitable for use in implementing at least some implementations of the present disclosure;

FIG. 2B is another functional block diagram of an example system for performing training of a speech diarization model using sort functionality suitable for use in implementing at least some implementations of the present disclosure;

FIG. 3 is an illustration describing the sorting functionality suitable for use in implementing at least some implementations of the present disclosure;

FIG. 4 is block diagram of an example diarization model including sorting layers suitable for use in implementing at least some implementations of the present disclosure;

FIG. 5A is block diagram of an example diarization model layer including sorting functionality suitable for use in implementing at least some implementations of the present disclosure;

FIG. 5B is an illustration describing the variance sorting functionality suitable for use in implementing at least some implementations of the present disclosure;

FIG. 6 is a block diagram of an example automatic speech recognition and diarization system suitable for use in implementing at least some implementations of the present disclosure;

FIG. 7 is a flow diagram of an example method of speech diarization suitable for use in implementing at least some implementations of the present disclosure;

FIG. 8 is another flow diagram of an example method of speech diarization suitable for use in implementing at least some implementations of the present disclosure;

FIG. 9 is a flow diagram of an example method of training a speech diarization model suitable for use in implementing at least some implementations of the present disclosure;

FIG. 10 is a flow diagram of an example method of automatic speech recognition and diarization suitable for use in implementing at least some implementations of the present disclosure;

FIG. 11A is a block diagram of an example generative language model system suitable for use in implementing at least some implementations of the present disclosure;

FIG. 11B is a block diagram of an example generative language model that includes a transformer encoder-decoder suitable for use in implementing at least some implementations of the present disclosure;

FIG. 11C is a block diagram of an example generative language model that includes a decoder-only transformer architecture suitable for use in implementing at least some implementations of the present disclosure;

FIG. 12 is a block diagram of an example computing device suitable for use in implementing at least some implementations of the present disclosure; and

FIG. 13 is a block diagram of an example data center suitable for use in implementing at least some implementations of the present disclosure.

### DETAILED DESCRIPTION

This disclosure relates to systems and methods for transformer-based end-to-end speech processing, such as for end-to-end speaker diarization and multiple speaker speech recognition. For example, audio data that represents speech from any number of speakers, where associations between each speaker and their speech may not be known, can be processed into a data structure in which the speech from each speaker is indexed with an identifier of the speaker.

Some speech diarization techniques can use machine learning models, such as encoder-decoder models. However, such techniques can require computationally intensive processes to account for possible assignments between speakers and the speech of the speakers. For example, some machine learning models use permutation-invariant training, in which the models are trained based on calculating all possible permutations (of speaker-speech assignments) in order to find the permutation that results in a lowest error. However, such training can be on the order of O(n3) due to the types of loss calculations and/or matching required, such as by relying on bipartite matching (e.g., Hungarian algorithm matching). In addition, the computational requirements of such architectures can make it challenging for real-time or near real-time speech diarization, such as for online/streaming speech processing. For example, in such applications, the system may be expected to process chunks of speech data, rather than an entire set of speech data. This can be challenging to achieve with matching algorithms that operate in addition to the neural network model. Further, such machine learning model architectures can rely on decoders, multiple heads, attractors, and/or sequence to sequence architectures, increasing the complexity of the architecture and/or training. These machine learning models can also be susceptible to overfitting by capturing qualities of the speech itself, such as color and tone of sound, rather than patterns representative of speaker identities. As such, the machine learning models may only perform well on the domain of the training data, rather than being able to perform on data beyond the domain of the training data (e.g., unseen domains).

Systems and methods in accordance with the present disclosure can allow for more effective speech diarization by implementing sorting of the input embeddings to the machine learning model architecture. The sorting can allow for at least some reduced usage of permutation invariant training. The sorting can obviate the need for complex architectures, such as architectures that rely on decoders and/or attractors. This can allow for faster and/or more accurate diarization, such as to allow for real-time or near real-time diarization to be performed. In addition, this can allow for greater flexibility of the number of speakers, such as where speakers may join or leave a conversation.

For example, the system can sort speech embeddings, where the embeddings correspond to sequences of acoustic features detected from an audio recording, based on one or more characteristics of the embeddings. For example, the system can sort speech sequences to form sorted speech sequences. A speech sequence, for example, can be a dimension of an embedding of speech for a sequence of time periods or slices (e.g., a dimension of the embedding after any layer of a machine learning model, a dimension of the input embedding, or a speaker array). For example, the system can sort a speech sequence based on a statistic of the embedding (e.g., variance of the embedding dimensions), or based on an arrival time of the speaker associated with a dimension of the embedding (e.g., the time slice the speaker is first determined to be speaking). The system can output a speaker array indicating if a speaker is speaking during a given time slice. A speaker array can be an array of logicals or of values (e.g., representing a probability that a speaker was speaking). The system can provide the sorted embeddings (e.g., speech sequences, speaker arrays) to one or more second encoders of the one or more neural networks, to cause the one or more second encoders to determine (e.g., predict, estimate) a speaker identifier to assign to each sequence. To train/update the one or more neural networks, the system can determine one or more losses between the determined speaker identifiers and target (e.g., ground truth) identifiers of the embeddings. This can include, for example, an entropy-based loss, such as binary cross-entropy loss. In some implementations, the system also performs at least some permutation-invariant training, e.g., using a permutation invariant loss, in addition to the sorting, which can allow the system to handle complex inputs from a larger number of speakers, while retaining the computational efficiencies achieved using the sorting.

The system can be implemented as part of a speech recognition and/or language model (e.g., LLM, VLM, etc.) architecture. This can be facilitated by the neural network architecture, which can allow for more effective joint loss training with automated speech recognition (ASR) and/or LLM training. For example, a joint training operation can be performed based on one or more losses associated with (i) transcript data (e.g., ASR embedding-based transcripts) from the audio recording and (ii) speaker assignments determined by the sort-based neural network architecture; this joint training can be performed to configure (e.g., train, update, fine-tune) the ASR and/or LLM as well as the sort-based neural network architecture.

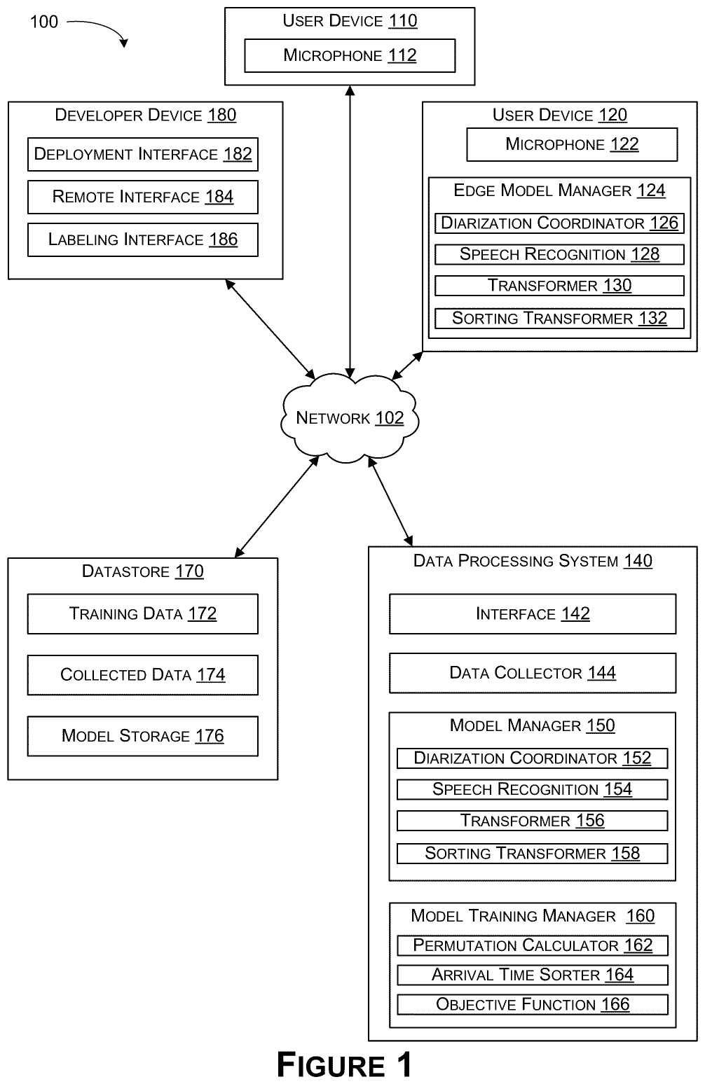

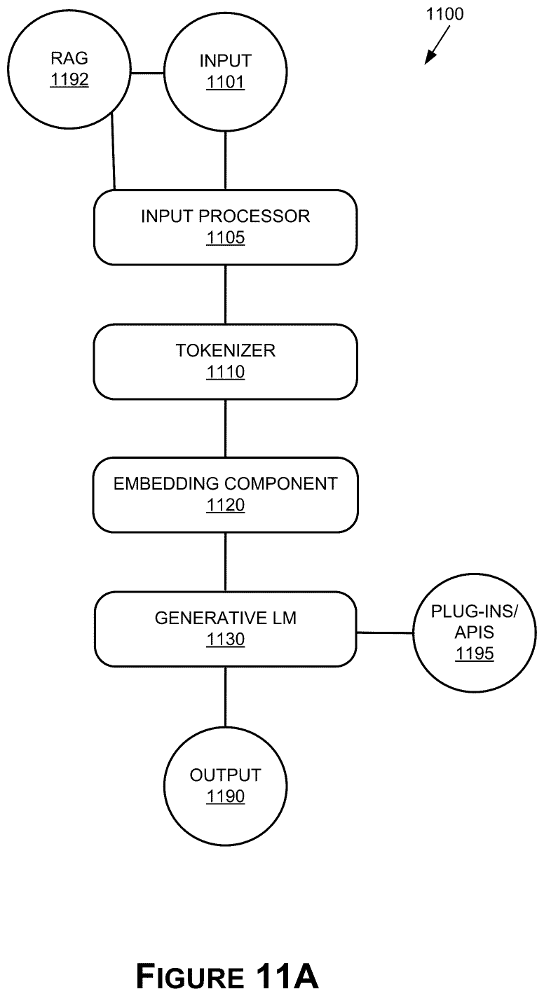

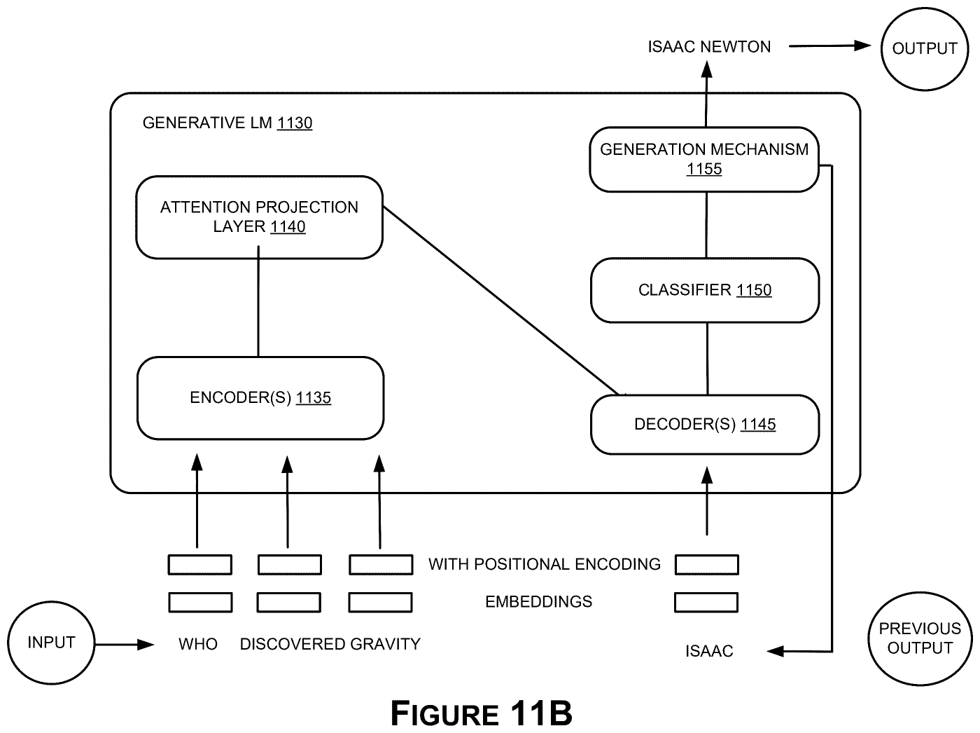

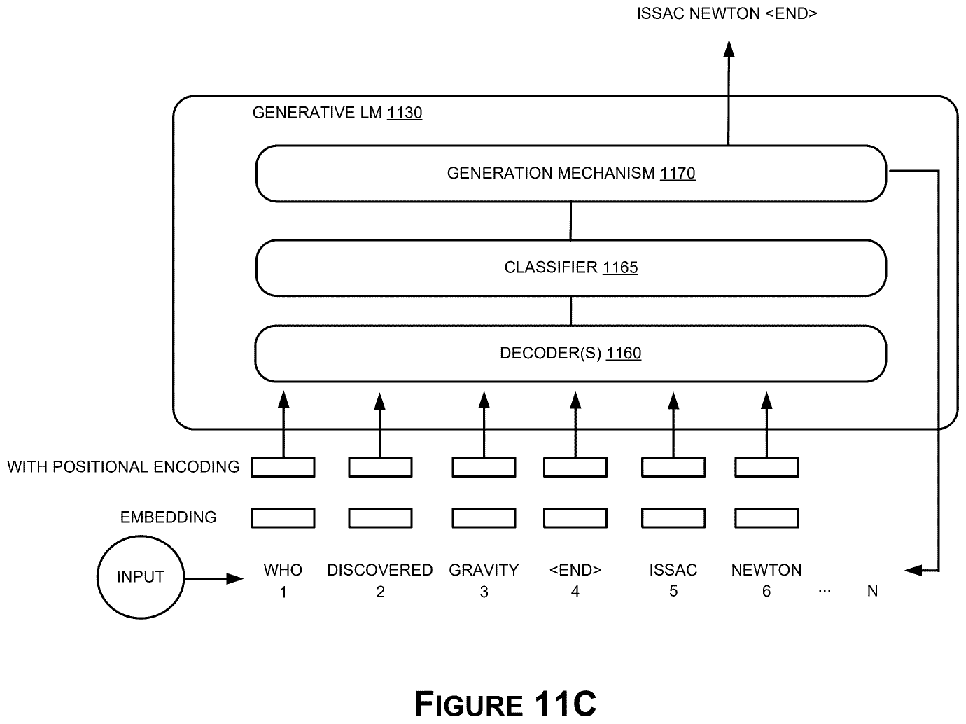

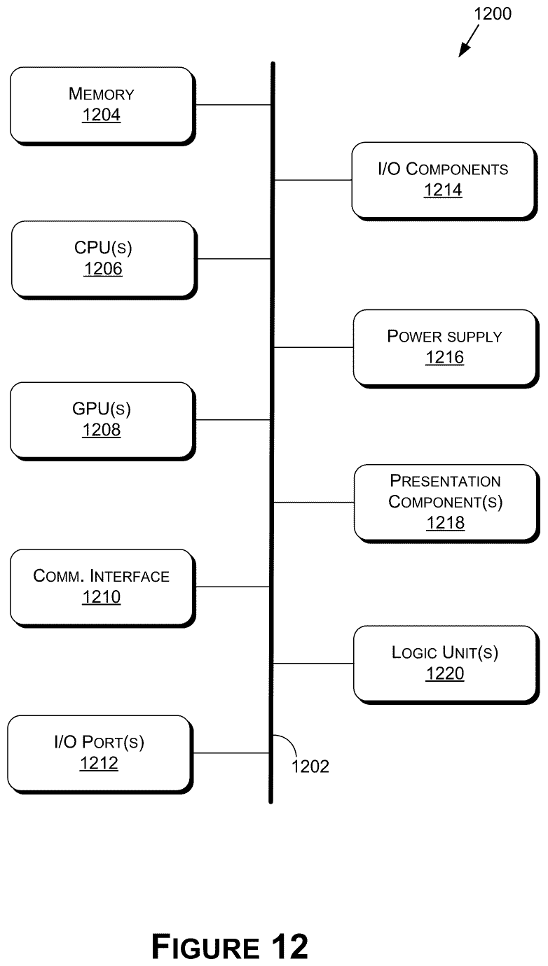

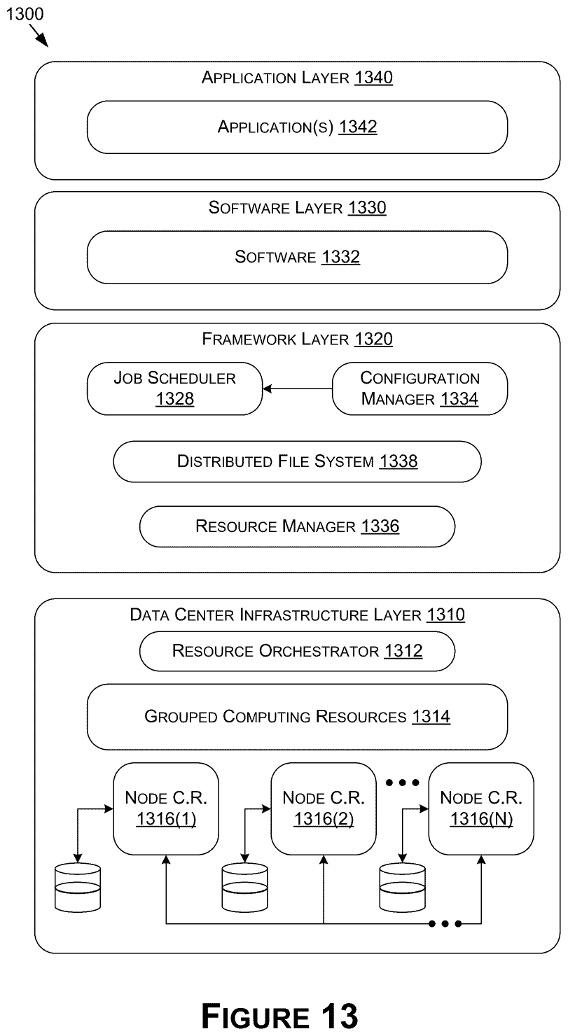

With reference to FIG. 1, FIG. 1 is an example system for diarization of multiple speakers, in accordance with some implementations of the present disclosure. In some implementations, diarization refers to converting sound received from a microphone and attributing the sounds to a specific speaker. Diarization can also include converting the sounds into words (e.g., text for display). For example, diarization can be used to create a transcript of a teleconference with multiple speakers. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out using one or more processors executing instructions stored in one or more memories. For example, in some implementations, the system and methods described herein may be implemented using one or more generative language models (e.g., as described in FIGS. 11A-11C), one or more computing devices or components thereof (e.g., as described in FIG. 12), and/or one or more data centers or components thereof (e.g., as described in FIG. 13).

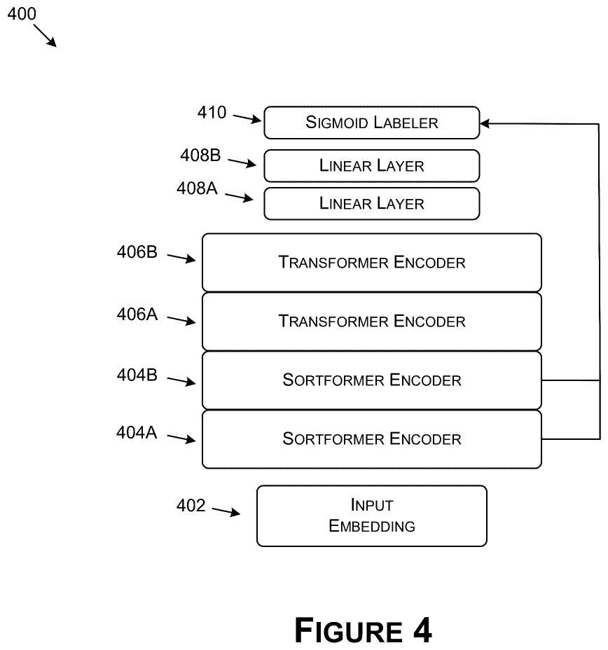

FIG. 1 shows a block diagram of system 100 (e.g., a diarization system). The system 100 can provide online functionality wherein new audio is processed by a trained model. The system 100 can also provide training (e.g., learning) functionality wherein collected and labeled data is used to adjust the parameters of a diarization model (e.g., model 400 of FIG. 4). In some implementations, the system 100 also provides automatic speech recognition (e.g., to transcribe the speech). In some implementations, the system 100 can deploy a diarization model to a user device (e.g., user device 120) for local processing.

In some implementations, a system 100 (e.g., diarization system) includes at least one user device (e.g., user device 110, user device 120). The user device 110 can be any user device capable of recording and/or streaming audio data (e.g., with microphone 112) and sending the audio data over a network 102 to a data processing system 140. The user device 120 can be a smart user device that can perform speech diarization using on-board diarization models in addition to capturing audio data (e.g., using microphone 122).

The user device 120 can include an edge model manager 124, which can store and/or control operation of one or more models to perform operations such as diarization. The edge model manager 124 can include or store one or more forms of diarization models or components thereof. For example, the edge model manager 124 can include a transformer 130, a sorting transformer 132, or any component of an artificial intelligence diarization model including, but not limited to: encoders, decoders, multi-head attention layers, feed-forward layers, pooling embedding layers, and/or labeling layers. The sorting transformer 132 will be described in more detail herein. In addition to the forms of model architecture components, the edge model manager 124 can include information related to how those components are connected and/or parameterized for a particular functionality.

In some implementations, the edge model manager 124 can be containerized or portions thereof can be containerized. Containerization can allow all forms of a diarization model to be the same across all devices. For example, both the user device 120 and the data processing system 140 can run containers generated from the same or a similar image.

The diarization coordinator 126, for example, can store the parameters of multiple transformer encoder layers, multiple sorting transformer encoder layers, and the connections between them that provide diarization of multiple speakers. In some implementations, the diarization coordinator 126 performs diarization by using a model (e.g., the transformer 130, the sorting transformer 132) that depends on various criteria, such as the number of speakers, the language of the speakers, the amount of background noise, etc. The diarization coordinator 126 can store, the parameters, and connections for several models and the select the proper model to perform diarization.

In some implementations, the edge model manager 124 includes a speech recognizer 128. The speech recognizer 128 can perform automatic speech recognition and can and transcribe the audio information into words of a different format (e.g., strings, character arrays, etc.).

In some implementations, a user device (e.g., user device 110 or 120) can have the required processing circuitry to generate embeddings of the audio data but not run the full diarization model. The embeddings can be communicated to the data processing system 140 at any point within a diarization model's architecture (e.g., after initial embedding, after one encoder layer) in order to best balance operational expense in the cloud.

In some implementations, the system 100 includes the data processing system 140. The data processing system 140 can receive audio from a user device (e.g., the user device 110, the user device 120) for diarization. In some implementations, the data processing system 140 receives data from more than one user device that is all to be part of the same diarization. The data can be merged and diarization can be performed on the combination of the devices or diarization of the audio data can be performed separately for each user device and then combined. The latter has the advantage of maintaining information related to the subset of speakers that are present at each user device and thus in each audio stream and/or recording. Similarly, in some implementations, the data processing system 140 receives speech data from a user device with more than one microphone (or a room may have more than one user device). In such cases, information related to the cross-correlation between microphones and/or devices can be used to simplify the diarization problem. For example, a relative volume across the microphones and/or devices can provide additional information in determination of the speaker at any given time.

In some implementations, the data processing system 140 is implemented on a node in a cluster of computers, on a service class computer device, or on a computer with specialized hardware (e.g., a graphics processing unit (GPU)). The data processing system 140 can have significantly more computational resources available than the user device 120. The model manager 150 can include models with more parameters and/or more layers than the edge model manager 124. The data processing system 140 can be used to perform diarization for user devices that include the edge model manager (e.g., in the user device 120). For example, a newer model may be available that has not yet been deployed to the user device 120 or the user device 120 may not have the computational or memory resources to run the model of the model manager 150. In some implementations, the user device 120 can perform diarization, but send audio information to the data processing system 140 for further analysis if a criterion is met. For example, the diarization coordinator 126 can output a level of certainty with its identification of speakers at each time slice and forward, to the data processing system 140, any time slices for which the certainty is below a threshold (or uncertainty is above a threshold).

In some implementations, the data processing system 140 includes an interface 142. The interface 142 can provide a method for communicating jobs and/or tasks to the data processing system 140. For example, the interface 142 can be a representational state transfer (REST) application programming interface (API), use simple object access protocol (SOAP), use a remote procedural call (RPC), or any other method for requesting information and/or initiating jobs on the data processing system 140. A user device (e.g., user device 110 or 120) can use the interface 142 to initiate diarization or send data to store for training. A developer device 180 can use the interface 142 to initiate training, configure the training process, or cause a new model to become active (e.g., move a model from a quality assurance environment to the live environment).

In some implementations, the data processing system 140 includes the data collector 144 to collect and/or identify data used for training. When data is received by the data processing system 140, that data can be processed by the data collector 144. The data collector 144 can identify new speech data that would be useful for training new models and/or adjusting existing models and communicate that data to the datastore 170 to be included in future training data set. For example, data collector can calculate criteria related to determining the novelty of the information contained in the new speech data. For example, the data collector 144 can keep track of the regions of the multidimensional feature space that are sparsely populated with training data and save data from those regions. Data collector can calculate a distance metric for the vector input to other training data and save data for which the distance metric is above a threshold.

The data processing system 140 can include the model manager 150. As previously described, the model manager 150 can be substantially similar to edge model manager (e.g., via containerization) or can implement more advanced diarization models.

In some implementations, the data processing system 140 includes the model training manager 160 to adjust or determine parameters that define the diarization models (e.g., the weights of any model layer). For example, training data can be stored in the datastore 170 and communicated to the data processing system 140 via the network 102 during training. A training sample can include the audio samples and/or their vector input embedding along with labeled speaker identities for each time slice (e.g., a ground truth label). The ground truth can be visualized as a two-dimensional array, wherein each row represents a speaker (e.g., each row is a speaker array), and each column represents a time slice. The entries in the array can be a logical (e.g., binary) value representing if the speaker was talking at a given time. For example,

| Time | 1 | 2 | 3 | 4 | 5 | 6 |
|---|---|---|---|---|---|---|
| Speaker A | 0 | 1 | 1 | 0 | 0 | 0 |
| Speaker B | 1 | 0 | 0 | 0 | 0 | 0 |
| Speaker C | 0 | 0 | 1 | 1 | 1 | 0 |

indicates speaker B started speaking during the first time slice, the speaker A spoke for the second and third time slice, speaker C also spoke during the third time slice and continued to speak in the fourth and fifth time slice, and no one was speaking during the sixth time slice. The two-dimensional array shown represents both a set of speaker arrays and a set of speech sequences (e.g., each dimension is a speaker).

In some implementations, model training manager includes the arrival time sorter 164. The arrival time sorter 164 can sort (e.g., order) speaker arrays in the ground truth data based on the first time the associated speaker is labeled. For example, during ground truth labeling a speaker can be assigned an arbitrary index (e.g., order). Order of the speakers in prediction may not be important to the diarization problem. It may not be important that a ground truth speaker (e.g., the person with employee identification number 123456) is labeled speaker A, rather only that the same speaker (e.g., row) is used each time the same ground truth speaker is speaking. The arrival time sorter 164 can also sort speaker arrays predicted by a model (e.g., of model manager 150). Sorting by the arrival time sorter 140 can allow for a comparison of the model prediction to the ground truth as required to calculate the objective (or loss) function 166. Sorting by arrival time (e.g., first time speaking) has a large computational advantage over permutation invariant learning/training (PIL). In PIL the permutation is selected by calculating the objective function 166 (e.g., cross-entropy loss) for each possible permutation and selecting the permutation that has the lowest value of the objective function. PIL can become especially computationally expensive when there are many speakers (e.g., the number of permutations is high).

In some implementations, model training manager 160 includes a permutation calculator 162. The permutation calculator 162 can be used to permute the ground truth and/or model predictions in certain scenarios where sorting both does not provide good performance (e.g., many speakers). Permutation calculator 162 can cause the calculation of the objective function 166 for all or a specific set of permutations and select the permutation with the best objective score for back propagation.

The model training manager 160 can include a back propagation routine in order to determine by how much to adjust model parameters based on a training sample or batch thereof during the training process. For example, back propagation can calculate the objective function 166 for the training sample or batch thereof by comparing predictions to the labels (e.g., ground truth) in the training data. The objective function 166 can, for example, be the cross-entropy loss for the speaker classifications performed on each time slice or speaker probability values calculated for each time slice. The back propagation routine can then calculate the gradient of the error with respect to each weight by propagating the gradients backwards, layer by layer, through the model and determine an adjustment to the weights of the model based on the training sample or batch thereof. During back propagation, the model training manager 160 can use (e.g., execute, evaluate) the models (e.g., the transformer 156 and the sorting transformer 158) of the model manager 150 to provide methods for calculating the gradients of the individual layers of the model.

In some implementations, the diarization system 100 includes the datastore 170. The datastore 170 can store data and/or models associated with the diarization process. The datastore 170 can include training data 172 that can be used by the data processing system 140 during a training procedure. The training data 172 can be a curated data set of audio data (or embeddings thereof) for which the diarization problem of identifying which speaker is speaking in each time slice has already been performed (e.g., manually by a human annotator). The training data 172 can include specifically identified validation and/or test data sets or data can be split into validation and/or test data by the data processing system 140 (e.g., by random selection). In some implementations, validation data is used to provide a criterion to stop the training process. For example, continued training can reduce the objective function with respect to the data used during back propagation, but training can be stopped when the loss function on the validation data increases for a number of epochs (e.g., training iterations). In some implementations, test data is used to compare the results of several potential models or modeling architectures explored by a model developer. For example, test data can be used to determine hyperparameters of the training procedure (e.g., batch size, when to stop training, number of layers, etc.).

The datastore 170 can also include collected data 174. The collected data 174 can include data that has been collected from a microphone and is awaiting human labeling (e.g., speaker annotation) before being added to the training set. For example, the data processing system 140 can determine a specific diarization input was difficult to classify or otherwise would be useful for training and send it to the datastore 170 for future use.

The datastore 170 also includes model storage 176 in some implementations. The model storage 176 is used to store any diarization models and/or other language models that can be used as part of the diarization procedure (e.g., automatic speech recognition models). The model storage 176 can also store models that are not actively being used by the data processing system 140 and/or a user device 120. For example, models that have been trained, but not deployed to any live system can be stored in the model storage 176. Model storage 176 can store models awaiting developer review or old models in case it is necessary to revert to an old revision after a new deployment.

In some implementations, the system 100 includes one or more developer devices (e.g., developer device 180). The developer device 180 can allow remote access to the data processing system 140 or the datastore 170 for various developer activities. The developer device 180 can provide a deployment interface 182 to allow the deployment of new models. For example, transitioning (e.g., deploying) a model held in the model storage 176 to either the model manager 150 or the edge model manager 124. The developer device 180 can provide a remote interface 184 to the datastore 170 and/or the data processing system 140, for example, to debug operations or otherwise configure the system. The developer device 180 can provide the ability to label the collected data 174 through a labeling interface 186.

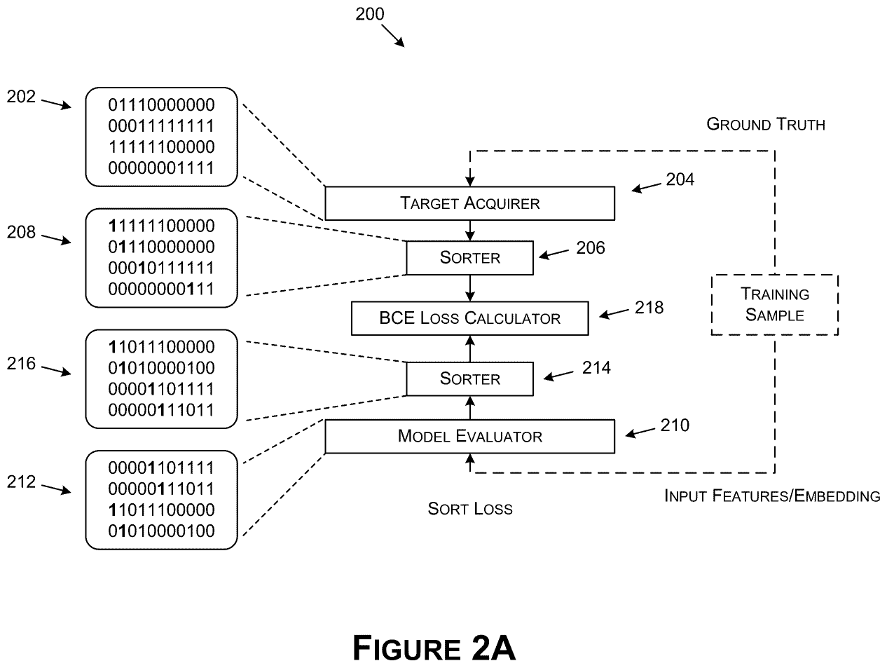

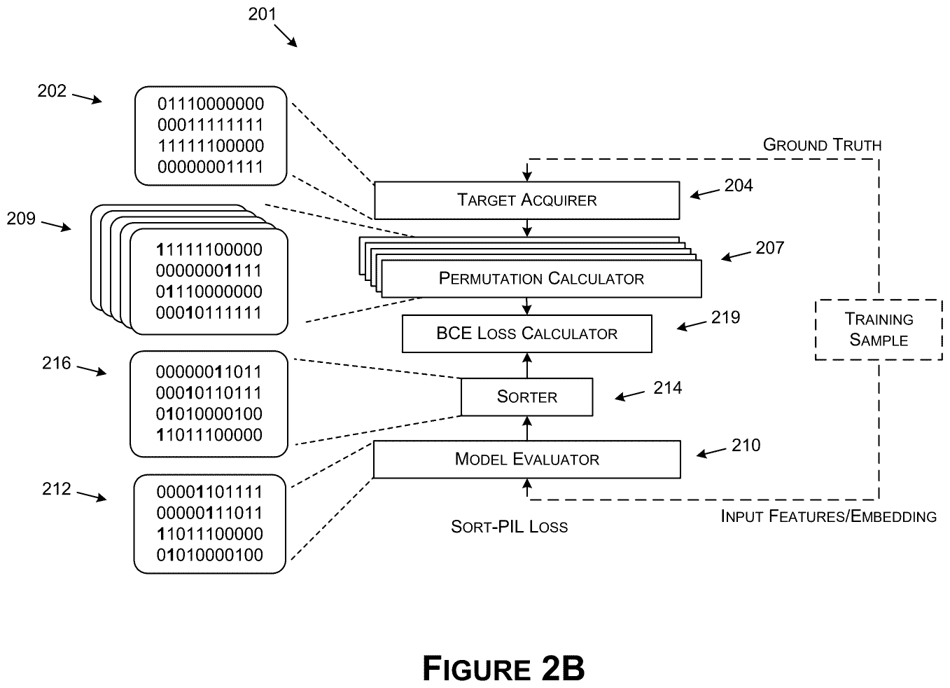

FIG. 2A is a block diagram of a training system 200 suitable for use in implementing at least some implementations of the present disclosure. Various functions of the training system 200 can be implemented by the components of the data processing system 140 (e.g., model manager 150, and the model training manger 160). The training system 200 can calculate the cross-entropy loss using the speaker arrival time sort function. FIG. 2A shows the functionality of training system 200 (e.g., a target acquirer 204, arrival time sorter 206 and 214, model evaluator 210, and binary cross-entropy (BCE) loss calculator 218 and shows example data (e.g., data 202, 208, 212, and 216) as it exits the related calculation block. Similar to the table above, illustrations of example data show a speaker as an individual row and a time slice as a columns, a logical ‘1’ is indicative of the speaker of the given row speaking during the given time slice. In some implementations, speaker arrays are not logical but instead are values on the range (0, 1). The values can represent probabilities that a speaker is talking in a given time period.

The training system 200 can perform a sort loss training procedure. In diarization training, multi-speaker speech ground truth examples can be assigned an arbitrary speaker index without reference to a specific person. For example, a specific person (e.g., employee 123456) can be associated with the first speaker array (e.g., row) or the second. Performing the loss calculation, however, can require a specific target be compared to the model output. Traditional methods rely on PIL to determine the permutation that should be used in the comparison for back propagation. In PIL, BCE loss can be calculated for every permutation of model prediction and every permutation of the ground truth target. The permutation with the lowest BCE loss can be used for back propagation. The number of permutations grows with the factorial of the number of speakers and can lead to high computational expense if the number of speakers is large. The sort loss procedure of the training system 200 can perform back propagation after performing only a single BCE loss calculation. Advantageously, the sort loss calculation as described can lead to a significant reduction in computational resource needs, power usage, the ability to train larger models, and the ability to perform training on less expensive hardware.

The sort loss training system 200 can select a training data sample including the input features/embeddings from the audio and the ground truth speaker identification according to some implementations. The sort loss training system 200 can select the training data based on the training algorithm used or the hyperparameters thereof. For example, the sort loss training system can contain instructions for selecting a specific batch size, determine if the selection is random, etc.

The sort loss training system 200 can include target acquirer 204 in some implementations. The target acquirer 204 can acquire (e.g., extracted or separated from the training sample) the ground truth (e.g., a target output of the diarization model) from the training sample selected. An example of the ground truth is shown in data 202, wherein in the data 202 shows four speaker arrays (e.g., the rows of the matrix).

In some implementations, sort loss training system 200 can include a sorter 206. The sorter 206 can, for example, be implemented by the arrival time sorter 164. The storer 206 can sort ground truth data by an arrival time order. For example, the arrival time order can be based on the first time slice each speaker array of the ground truth indicates that the respective speaker is speaking. After sorting, the first person to speak can be indexed as speaker 0 (e.g., the first row), the second speaker will be indexed as speaker 1, and so on as show in data 208.

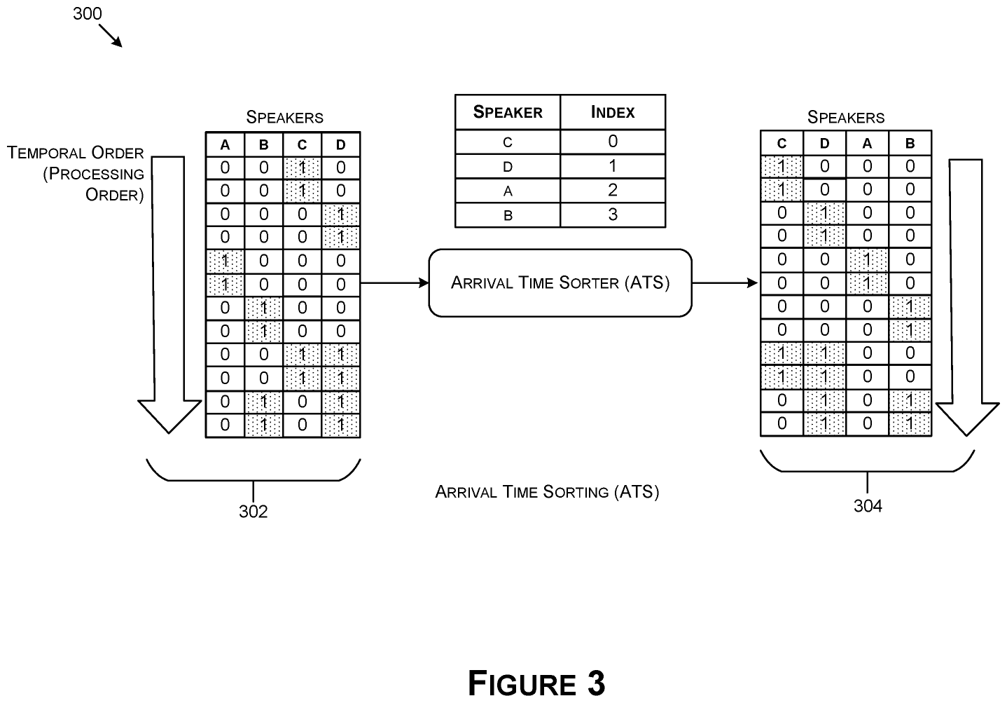

With reference to FIG. 3, an arrival time sort function 300 (e.g., arrival time sorter) is described in more detail in accordance with some implementations. The arrival time sort function 300 can be implemented in multiple locations in various implementations of the present disclosure. For example, the sorter 206 and 214; the arrival time sorter 164; and the sorting transformer 132 and 158 can all perform the arrival time sort function 300.

Diarization data 302 can, for example, be the output of a model (e.g., a model prediction) or a ground truth from training data. In FIG. 3, the diarization data is shown as transpose of the data in FIG. 2 and the example data above (e.g., rows are a time slice and columns are indicative of a unique speaker). The arrival time sort function 300 can receive the diarization data 302 and sort based on arrival time. For example, sorting can be performed by finding the first row for which there is a logical ‘1’ in each column and sorting the columns in order of the row found or by finding the first row for which the value is greater than a threshold (e.g., if the speaker array contains probabilities or other continuous values). In some implementations, data can be stored as a sparse matrix and columns could be sorted by their lowest row index contained in the matrix.

In the example shown in FIG. 3, speaker C receives column index 0 as they were speaking in the first time slice, speaker D was speaking in the third time slice and is assigned column index 1 in the sorted output data 304; this process is continued until all speakers are indexed in order. In some implementations, a different arrival time sorting function can be performed (e.g., first speaker with two consecutive time slices, first speaker with 4 of 5 consecutive time slices, etc.). For example, to improve order stability during initial training where speaker identifications may fluctuate leading to different orderings of the speakers in the model predictions and longer initial training times.

Referring again to FIG. 2A, the sort loss training system 200 can provide the input features/embeddings from the audio to the diarization model for evaluation in model evaluator 210. Model evaluator can be implemented by model manager 150 or training model manager 160, for example. Model evaluator 210 can calculate the model prediction data 212 by evaluating a diarization model.

In some implementations, sort loss training system 200 can also sort the output of the model evaluator by arrival time using sorter 214. The sorter 214 can perform the same arrival time sort as the arrival time sort function 206 or it can perform a variation on arrival time sort (e.g., first speaker with two consecutive time slices, first speaker with 4 of 5 consecutive time slices, etc.). The sorter 214 can output sorted data 216.

In some implementations, the sort loss training system 200 compares sorted model prediction (e.g., the data 216) and sorted ground truth (e.g., the data 208) using the BCE loss calculator 218. The BCE loss calculator 218 can be implemented, for example, by objective calculator 166. For example, BCE loss calculator 218 can perform the binary cross-entropy calculation by:

$$B C E = - \frac{1}{N} {\sum }_{i = 1}^{N} {g}_{i} log ( {p}_{i} ) + ( 1 - {g}_{i} ) log ( 1 - {p}_{i} ) ,$$

where gᵢ is any index of the ground truth diarization or speaker arrays and pᵢ is the output of the diarization. In some implementations, the sort loss training system can use a different loss calculator (e.g., general objective function, hinge loss, L1 loss, etc.) instead of BCE loss calculator 218.

As stated earlier, the sort loss training system 200 can allow the BCE loss calculation to be performed for only one permutation (e.g., the one sorted in accordance arrival time in sorter 206 and 214), rather than the large number of permutations that can be required by PIL. The gradients for the BCE loss calculation 218 given the permutation defined by the sorting function can be used to perform back propagation calculations in order to adjust the weights of the model used by model evaluator 210 prior to the next iteration (e.g., next training sample, batch, etc.).

It is contemplated that though the arrival time sort function 214 is shown external to diarization model 210, there can be instances where an arrival time sort function is used inside the model as well as just on the final output. For example, multiple layers can be used and the output of each layer can be sorted based on the arrival time of speakers in that layer's prediction. In addition, when new speakers are identified by the model sorting based on arrival time can naturally account for the speaker by assigning them the next available speaker index (i.e., finding the best permutation is not required even as the number of speakers grows).

FIG. 2B is a block diagram of an additional training system 201 suitable for use in implementing at least some implementations of the present disclosure. The training system 201 can also be used for the calculation cross-entropy loss using the speaker arrival time sort function. The training system 201 can include some aspects of the PIL training process in combination with arrival time sorting; for example, to mitigate potential issues with the stability of the model predictions early in the training process.

The training system 201 can, for example, be implemented by various components of the data processing system 140 including, but not limited to, the model manager 150 and the model training manager 160. In some implementations, the training system 201 can reuse several components of the training system 200.

FIG. 2B also shows example data as the data propagates through the training system 201. Example data (e.g., data 202, 209, 212, and 217) is shown as it exits the related calculation block. Similar to the table above, illustrations of example data show a speaker as an individual row and a time slice as a columns, a logical ‘1’ or higher value is indicative of the speaker of the given row speaking during the given time slice.

The training system 201 can select a training data sample including the input features/embeddings from the audio and the ground truth speaker identification according to some implementations using similar methods as those described for training system 200.

According to some implementations, the training system 201 includes the target acquirer 204, which has the same or similar function as in training system 200. For example, the target acquirer 204 can acquire (e.g., extract or separate) the ground truth (e.g., a target output of the diarization model) from the training sample selected. The ground truth can, for example, have the form of data 202.

In some implementations, the training system 201 includes one or more permutation calculator 207. The permutation calculator 207 can permute the ground truth data to form a number of ground truth orderings as shown by the permuted ground truth diarization data 209. The permutation calculator 207 can produce all of the possible permutations (e.g., the factorial of the number of speakers) or any subset of all possible permutations. For example, permutation module can use the model predictions to determine if some permutations can be dropped (e.g., no longer calculated) from those determined in the permutation module 207 the next time the same training sample is used. As the model used (e.g., being trained) takes on weights closer to their final value the output of model evaluator can become more consistent allowing for fewer permutations to be considered. In some implementations, the permutation module 207 can also chose the permutation related to the arrival time sort later in training when the model weights have begun to converge and model predictions are more stable (e.g., arrival time is more stable).

In some implementations, the training system 201 includes the model evaluator 210. The training system 201 can provide the input features/embeddings from the audio to the diarization model 210 to calculate the model output (e.g., prediction data 212, speaker arrays, etc.). Data 212 can be numeric values or contain a logical representation. Model evaluator 210 can be implemented similarly as in training system 200.

In some implementations, training system 201 can also sort the output of the model evaluator by arrival time using sorter 214. The sorter 214 can perform the same arrival time sort as the arrival time sort function 206 or it can perform a variation on arrival time sort (e.g., first speaker with two consecutive time slices, first speaker with 4 of 5 consecutive time slices, etc.). The sorter 214 can output sorted data 216.

In some implementations, the training system 201 compares sorted model prediction (e.g., data 216) to the various ground truth permutations (e.g., data 209) by performing the BCE loss calculator 219. The BCE loss calculator 219 can perform loss calculations similar to BCE loss calculator 218. After BCE loss is calculated for the combination of the sorted model predictions 216 and all the ground truth permutations 209 the BCE loss calculator 219 can select a permutation for use in parameter adjustment (e.g., back propagation). For example, the BCE loss calculator 219 can choose the speaker ordering (e.g., permutation) for which the BCE loss is the lowest or use another selection criterion such as the permutation used last time for this training sample, or a combination of criteria such as the BCE loss and previous usage. In some implementations, the permutation and loss calculation for which the BCE loss is lowest is used to calculate the gradients for the BCE loss calculation 219 and to perform back propagation calculations in order to adjust the weights of the diarization model 210 prior to the next iteration.

FIG. 4 is a block diagram of an arrival time based diarization model 400 suitable for use in implementing at least some implementations of the present disclosure. The arrival time based diarization model 400 is a system for determining the speakers active in a time slice. The arrival time based diarization model 400 can, for example, be implemented by various components of the model manager 150, the edge model manager 124. For example, instructions for performing a sorting transformer encoder layer can be included in the sorting transformer 132 or 158. Parameters including the number of layers and architecture of the model can be stored in the model storage 176 of the datastore 170 and/or transferred to the active model of model manager 150 or edge model manager 124.

The arrival time based diarization model 400 can be trained by the sort loss training system 200 or 201 and can implement the diarization model executed by model evaluator 210 in some implementations.

Diarization model 400 can include 2 sorting transformer encoder layers (e.g., sorting transformer encoder layer 404A-B), 2 transformer encoder layers (e.g., transformer encoder 406A-B), 2 linear layers (e.g., linear layers 408A-B) and a sigmoid labeler 410. Any number of layers can be used in some implementations, for example 3 sorting transformer encoder layers and 4 transformer encoder layers. In addition, different labeling (or output) layers can be used (e.g., a softmax instead of the sigmoid labeler) in some implementations; however, the sigmoid labeler applies well to the diarization problem where more than one speaker can be speaking at the same time.

According to some implementations, an input embedder 402 receives audio data (e.g., from the user device 110 or from the training data 172 depending on the current task). The input embedder 402 can convert the audio data into a features/embedding vectors that can be used by the rest of the of the diarization model 400. The input embedder 402 can perform preprocessing as necessary by later layers of diarization model 400. In some implementations, functionality of input embedder 402 is performed on a different device (e.g., user device 110 or 120) prior to being communicated to diarization model. For example, the datastore 170 can save training examples in their embedded form.

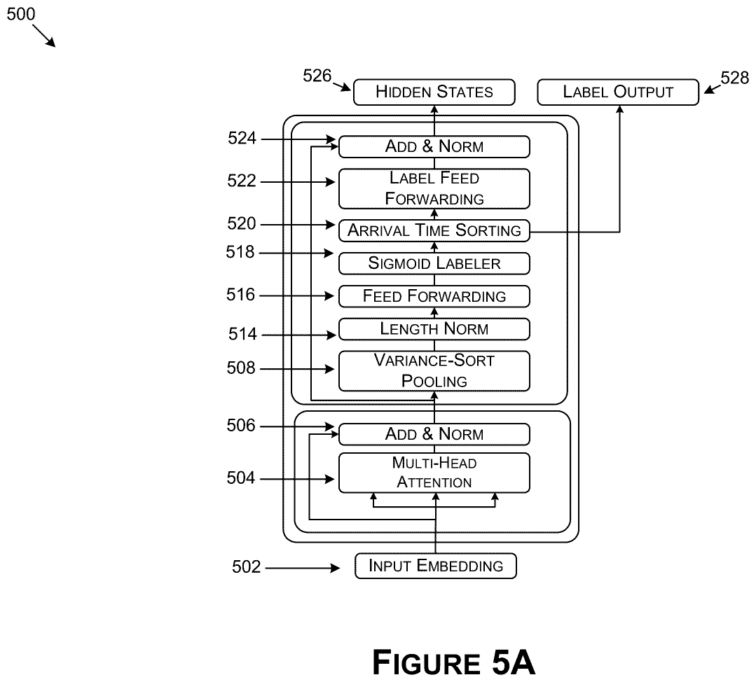

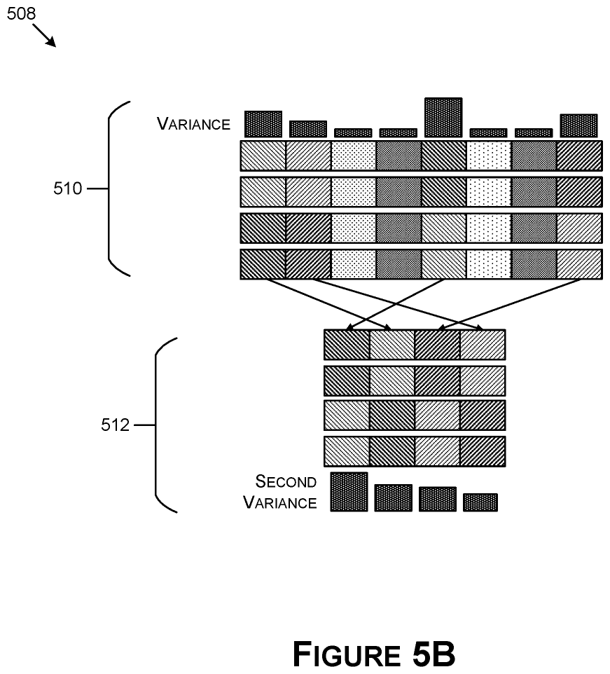

In some implementations, the diarization model 400 can include a sorting transformer encoder layer 404A. The diarization model 400 is shown with two initial sorting transformer encoder layers 404A and B; however, sorting transformer encoder layers can be used any point within the diarization model 400. Sorting transformer encoder layers (e.g., layer 404A and 404B) will be described in more detail with reference to FIG. 5A. In some implementations, sorting transformer encoder layer 404A can perform operations similar to a transformer encoder, but can also include an sort functionality (e.g., an arrival time sorter as described with reference to FIG. 3). An embedding (e.g., a number of speech sequences) can be provided to sorting transformer encoder layer 404A as its input. The sorting transformer encoder layers each can output both a set of hidden states (e.g., different embedding) as well as a sorted speaker label output (e.g., a number of speaker arrays). The hidden states can be passed to the next layer and the sorted label output can be passed directly to the sigmoid labeler 410.

Advantageously, it is possible to output labels from sorting transformer encoder layer to the sigmoid labeler to improve training time by increasing size of the back propagation gradient with respect to the weights of the earlier sorting transformer encoder layers. Because each output is sorted based on arrival time of the speakers, outputs of the individual sorting transformer encoder layers will add constructively together and with the final output of all layers.

In some implementations, the diarization model 400 can include a second sorting transformer encoder layer 404B. The first sorting transformer encoder layer 404A can send its hidden state output to the second sorting transformer encoder layer 404B. The second sorting transformer encoder layer 404B can perform similar functionality as first sorting transformer encoder layer 404A, for example, with different weights and/or additional, different, or removed sublayers. The second sorting transformer encoder layer 404B can send its hidden state output (e.g., new embedding, output speech sequences, etc.) to a first transformer encoder layer 406A and its diarization output to sigmoid labeler 410.

Arrival time based diarization model 400 can include a number of transformer encoder layers (e.g., layers 406A-B) in some implementations. The transformer encoder layers can be similar to sorting transformer encoder layers. For example, transformer encoder layers can have the same sublayers as sorting transformer encoder layers (e.g., layers 404A and B), however, can have the sort functionality not included. Similarly, transformer encoder layers can pass their hidden state output to the next layer without calculating a diarization output. The transformer encoder layer 406A passes its hidden state output to the transformer encoder layer 406B. However, the transformer encoder layer 406 cannot, for example, pass its output directly to the sigmoid labeler 410 as the unsorted output may not add constructively with other outputs (e.g., from the sorting transformer encoder layers). which passes its hidden state outputs to the next layer of the diarization model 400. Any number of transformer encoder layers can be used in diarization model 400.

In some implementations, the diarization model 400 can include a number of linear layers (e.g., linear layers 408A and B). Linear layers can perform a linear or affine transformation on the output of the previous layer (e.g., perform a matrix multiplication with an additive term). The linear layers can either increase or decrease dimensionality of the embedding leaving a layer depending on the size of the matrix defining the linear transformation. In addition, linear layers can also impose an activation function on the output of the affine transformation (e.g., on each dimension of the output). The activation function adds nonlinearities to the system that can allow greater representative potential by the network. For example, sigmoid functions, rectified linear units (ReLU), Gaussian error linear units (GeLU), any other appropriate activation function, or a combination thereof can be used as activation in a linear layer. In some implementations, the final linear layer 408B can decrease the dimensionality of its output to that of the sigmoid labeler 410, which is equal to the speaker capacity of the diarization model 400 (e.g., the maximum number of speakers that diarization model 400 can distinguish).

In some implementations, the diarization model includes the sigmoid labeler 410. Sigmoid labeler can apply a sigmoid function to cause the outputs of the to be on the range (0, 1) and allow for the interpretation as probabilities that a speaker is speaking during a given time slice. For example, the output associated with each speaker can be given by:

$${p}_{i} = \frac{{e}^{{x}_{i}}}{1 + {e}^{{x}_{i}}} ,$$

where pᵢ is the output of the sigmoid labeler 410 associated with the i^{th} speaker and xᵢ is the input to the labeler for the same speaker. In some implementations, other labeling functions can be used (e.g., soft max, threshold function, etc). For example, a threshold function can be applied instead of the sigmoid labeler 210 or after the sigmoid labeler 210 to to create an indication of if the speaker associated with an output sequence is speaking during a given time slice of the sequence.

FIG. 5A is a block diagram of a sorting transformer encoder layer 500 suitable for use in implementing an encoder layer of diarization model 400 (e.g., sorting transformer encoder layer 404 A and B) in at least some implementations. The sorting transformer encoder layer 500 can the accept input embedding 502. The input embedding can be an initial embedding (e.g., features extracted from the audio including, frequency, cadence, etc.) or an embedding calculated from another encoder layer (e.g., the hidden states output from an earlier encoder).

In some implementations, encoder layer 500 includes a multi-head attention layer 504. The input embedding 502 can be input to an attention layer including the multi-head attention layer 504. Prior to the multi-head attention layer 504 inputs can receive positional encoding information and/or be repeated to form the three inputs shown for the multi-head attention layer 504. Positional encoding can include adding information to the input that captures the relative temporal order of the inputs to sorting transformer encoder layer 500. For example, the vector input's temporal index can be input to sine and cosine functions of various frequencies and added to the inputs.

The multi-head attention layer 504 can have a configurable number of heads, h. Each head of the multi-head attention can output a value similar to a key-value lookup. For example, the three inputs to the multi-head attention layer 504 can form a query set, Q, a set of keys, K, and a set of value, V. To determine the appropriate value for a given query, a head of the multi-head attention layer 504 can compute a compatibility or look up function to determine which values to choose. For example, headᵢ=attention(QWᵢ^{Q}, KWᵢ^{K}, VWᵢ^{V}), where the attention function is defined by attention(Q, K, V)=softmax(QK^{T})V can be used to compute the compatibility function and output a value for each query. In some implementations, the input to the softmax can be scaled (e.g., by the dimension of a key in K) in order to avoid issues in training where the gradient vanishes or becomes very close to zero. The output of the multi-head can then concatenate all the heads and multiplies by another linear transformation that resizes the output (e.g., the number of time slices by the number of embedding dimensions).

In some implementations, the output of the multi-head attention layer 504 is added to the input, in an add and normalize function 506. To facilitate this residual connection, the input and output of the multi-head attention layer 504 can have the same dimensionality in some implementations.

The Sorting transformer encoder layer 500 can include a variance-sort pooling layer 508. The variance-sort pooling layer 508 advantageously reduces the dimension of the input embedding by keeping only the dimensions with the greatest variance. Eliminating dimensions with little variance can allow sorting transformer encoder to focus only on the differences between the inputs potentially improving discrimination between speakers and causing less focus on acoustic channel information (e.g., microphone transfer function, reverberation, background noise, channel bandwidth, etc.) of the training samples.

With reference to FIG. 5B, the variance-sort pooling layer 508 is described in more detail in accordance with some implementations. An input 510 can be applied to a variance-sort pooling layer 508. In FIG. 5B the columns indicate a dimension of the input embedding (e.g., features) and rows indicate a time slice of the sequence. The hashing or half-tone fill indicates a degree of the value of the embedding dimension at that time slice. For example, column 3 has similar half-tone fill for each row indicating that the values in these locations of the input matrix are similar. Thus, the variance of that dimension (e.g., that column) is small across all values in the speech sequence as indicated by the bar chart above. As a second example, column 1 has light hashing for the first two time slices and dark hashing for the third and fourth time slices indicating that the first and second values, while similar, are different than the third and forth values. Thus, the variance of that dimension (or speech sequence) is high.

The variance-sort pooling can sort the dimensions of the input embedding (e.g., to this layer) based on the variance of their dimension from highest to lowest and eliminate a number of dimensions with the lowest variance (e.g., the 4 dimensions with the lowest variance). The output 512 shows the respective output for the input 510 after propagation through the variance-sort pooling layer 508. The fifth dimension (e.g., largest variance) becomes dimension 1, the second largest variance becomes dimension 2, and so on. The four dimensions with the lowest variance (dimensions 3, 4, 6, and 7) were removed (e.g., do not propagate further in the encoder layer). FIG. 5B illustrates an example of variance-sort pooling. In some implementations, the number of dimensions can be in the hundreds or even thousands. Removing even a quarter of the dimensions with the lowest variance can lead to a significant savings in the computations required to train and/or execute the resultant diarization model. In some implementations, speech sequences can be sorted by a value other than the variance. For example, after the dimension with the most variance is assigned dimension one, the next dimension can be based on variance in directions orthogonal to the first dimension or an amount of independent information provided. In some implementations, dimensions can be removed (e.g., get zero weight, etc.) without sorting the dimensions. For example, all dimensions with variance less than a threshold can be removed.

Referring again to FIG. 5A, the output of the variance-sort pooling layer 508 can be normalized based on the new dimensionality in the normalization layer 514 prior to propagation further through the sorting transformer encoder layer 500. The lower dimension embedding can be propagated through a feedforward layer 516.

In some implementations, encoder layer can include feedforwarding 516. Feedforwarding can have a number of sub layers to increase the representation capability of the layer by performing a number of linear transformations followed by activation functions. In some implementations, the feedforward layer 516 can decrease the dimensionality of the input sequence to equal the maximum number of speakers supported by the network. For example, an example network can support at most 32 speakers; the variance-sort pooling layer 508 can reduce the input embedding dimensionality of 512 to 128 based on variance and the feedforward layer 516 can further reduce the dimensionality of the output to the maximum of 32 speakers.

In some implementations, the output of the feedforward layer 516 can be passed to the sigmoid labeler 518. Sigmoid labeler 518 can perform the same or similar functions as sigmoid labeler 410 of diarization model 400, but within an individual encoder layer (e.g., to provide an output of the layer directly to the output layers of the diarization model 400. The sigmoid labeler 518 can assign a number between 0 and 1 associated with the probability that a particular speaker was speaking in each time slice. Because in a diarization problem there is the possibility that more than one speaker is talking at the same time, the sigmoid classification function can be advantageous as a high value for one speaker doesn't preclude a high value for another speaker; however, other functions can be used (e.g., softmax).

In some implementations, the output of the sigmoid labeler 518 can be passed to an arrival time sorter 520 where the speaker arrays are sorted based on their arrival time (e.g., in accordance with the description of FIG. 3). Sorting the speakers based on arrival time has the benefit of being able to add or otherwise combine the label output of any sorting transformer layer with another layer that has been sorted based on arrival time. For example, in FIG. 4 the output of the sorting transformer layers 404A-B can be combined with the overall output from all layers.

The output of the arrival time sorter 520 can be passed out of the sorting transformer encoder layer 500 to form the output 528 and passed as input to label feedforwarding 522. The label feedforwarding layer 522 can have a number of sublayers (e.g., linear layers) to increase the representation capability of the layer. The sublayers can impose activation functions at the output of each sublayer as described previously.

To facilitate a residual connection from the input to the variance-sort pooling layer 508 to the output of the label feedforwarding 522, the label feedforwarding 522 can increase the dimensionality back to that of the input. In some implementations, the output of the label feedforwarding layer 522 is added to the input of the variance-sort pooling layer 508 and normalized before being output from the sorting transformer encoder layer 500 as the hidden states 526. In some implementations, the residual connection does not bypass variance-sort pooling 508, instead the residual connection can begin the bypass prior to the feedforward layer 516 or a sub layer of the feed forward layer 516 (e.g., one of potentially several affine transformations and activation functions). For example, a residual connection stemming from these layers can allow the dimensionality of the hidden states 526 to be different than the input.

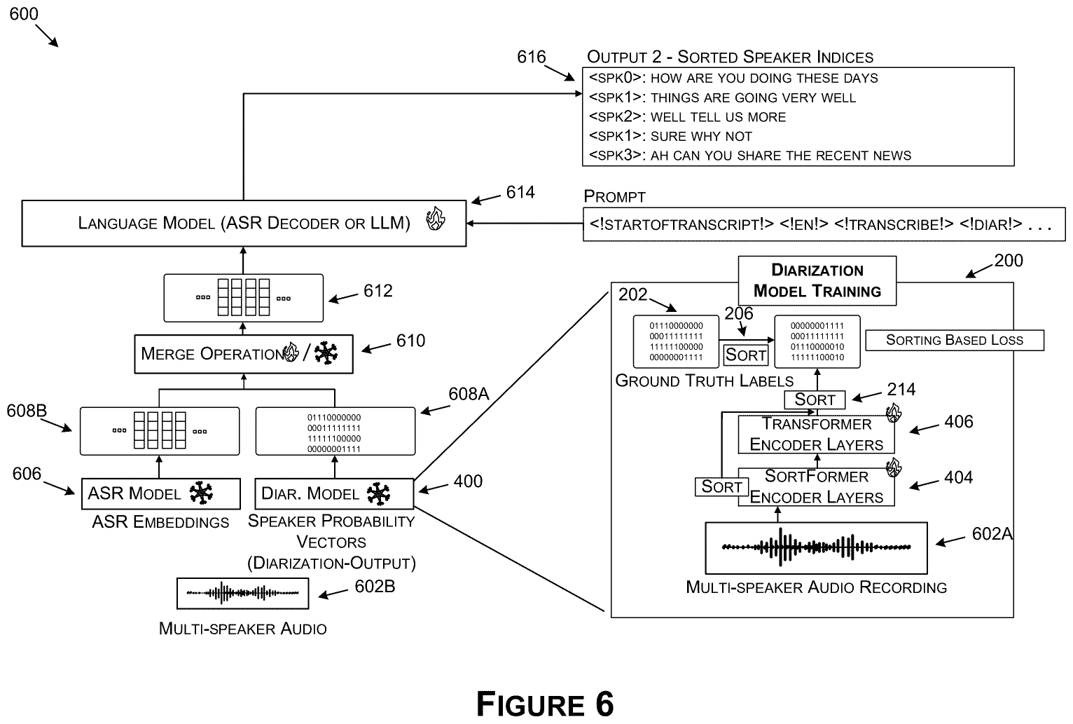

FIG. 6 is a functional block diagram of a diarization and speech recognition system 600 suitable for implementation by the components of the diarization system 100 in accordance with some implementations. FIG. 6 represents a system for both diarization and automatic speech recognition and shows how the elements described so far can be used in a system that samples audio (e.g., multi-speaker audio 602B) and converts it into a diarized transcript 616. The diarization and speech recognition system 600 can include both training functionality (e.g., training system 200 or 201) and the diarization functionality implemented by the diarization model 400. In some implementations, the diarization and speech recognition system 600 can include an automatic speech recognition (ASR) model 606, a merge operation 610, and a language model 614. Fire and ice icons in FIG. 6 can indicate if parameters of the functionality are changing during processing, according to some implementations. For example, the diarization model 400 has a constant set of parameters during online execution whereas components thereof (the sorting transformer encoder layers 404 and the transformer encoder layers 406) have changing parameters during the training process.

The training system 200 of the diarization and speech recognition system 600 can be used to determine parameters (e.g., weights) for the diarization model 400. A training sample, including a multi-speaker audio recording 602A and ground truth labels, can be obtained from a data store (e.g., the datastore 170). The data can be presented as an input (e.g., for evaluation) to the diarization model with the current diarization model parameters. For example, diarization model can be the diarization model 400 with the sorting transformer encoder layers 404 and the transformer encoder layers 406. The sorting transformer encoder layers 404 can include a sorted label bypass path around the transformer layers and help in rapid tuning of the earlier sorting transformer layers as discussed with reference to FIGS. 4 and 5A. The sorted output from all layers and the bypass paths can be added together or otherwise combined to form a single sorted model predicted diarization output leaving the arrival time sorter 214.

The model predicted diarization can be compared to the ground truth labels 202, for example, sorted by the arrival time sorter 206 using an implementation of the training system 200. In some implementations, the diarization and speech recognition system 600 can instead implement training system 201 (e.g., to use various permutations of the speaker order in the ground truth) or another suitable training function. Back propagation can be used to adjust the model parameters (of the various layers) according to the gradient of the BCE loss with respect to the parameters. The BCE loss used can be used from the comparison of the sorted ground truth to the sorted model prediction (e.g., training system 200) or the lowest BCE lost across all permutations of the ground truth (e.g., training system 201) as compared to the sorted model predicted diarization. After completing training, the final model parameters can be saved in a datastore (e.g., the datastore 170) and await deployment to the online diarization model 400. The process of deploying a new model or any model from the datastore 170, for example, can be executed, for example, by the developer device 180.

The online portion of the diarization and speech recognition system 600 is shown on the left of FIG. 6. Diarization can begin with novel multi-speaker audio 602B in accordance with some implementations. Multi-speaker audio 602B can be previously recorded for processing after the completion of what is to be diarized or multi-speaker audio 602B can be an audio stream. As previously mentioned, the features of the present disclosure can provide various advantages over other techniques when the audio is streamed. For example, because the model output is always in sorted order based on arrival time, a new speaker does not affect previous speaker index assignments (in contrast to matching a current indexing scheme with the output of each subsequent model prediction). The new speaker can simply receive the next available index.

Multi-speaker audio can be divided into time slices before embedding the features of the audio signal (e.g., frequency, cadence, etc.) into a vector input. Time slices can be periodic in nature (e.g., each time slice representing a set amount of time), can be determined based on audio signal level (e.g., split at points where the audio signal is at a background noise level), or can be determined based on other features of the audio signal. The multi-speaker audio 602B can be embedded into a vector form (e.g., features extracted, transformations performed, etc.) prior to being input to the diarization model 400 or the automatic speech recognition (ASR) model 606. In some implementations, the automatic speech recognition (ASR) model 606 uses different time slices and/or different vector embeddings than the diarization model 400.

In some implementations, diarization embeddings can be presented (e.g., used during evaluation, forward propagation, etc.) as an input to the diarization model 400 to obtain speaker probability vectors and/or the diarization output 608A (e.g., speaker arrays). ASR embeddings can be presented as an input to the ASR model 606 to obtain the text language embedding 608B.

In some implementations, the diarization and speech recognition system 600 can include a merge operator 610. The diarization output 608A and the text language embedding 608B can be combined by a merge operator 610. The merge operator 610 can, for example, combine the diarization output 608A and the text language embedding 608B to form a speaker labeled text language embedding 612 that can be interpreted by the language model 614. The merge operator 610 can, for example, determine a relationship between the time slices of diarization output 608A and the text language embedding 608B so that the text (e.g., words, phrases, etc.) can be associated with a specific speaker index.

The language model 614 can include an ASR decoder and/or a large language model (LLM) (or other language model type). In some implementations, the language model 614 can generate the text output in the diarized transcript 616 based on the text language embedding 612 and tag the words or sentence with the appropriate speaker based on the diarization output 608A. In some implementations, the language model 614 can begin transcription based on a prompt from a user. For example, an interface to a general LLM provided by a user device (e.g., user device 110 or 120) can recognize spoken words such as “begin transcription”, “start diary”, or similar phrases, or recognize text entered into a chat window of similar substance. The user device can send a prompt to the diarization and speech recognition system 600 to begin recording audio to process into a diary or transcript.

In some examples, the machine learning models/neural networks of the present disclosure may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model (e.g., weights and biases). In some instances, such as where the machine learning model is small enough (e.g., has a small enough number of parameters), the model may be included within the container itself. In other examples—such as where the model is large—the model may be hosted/stored in the cloud (e.g., in a data center) and/or may be hosted on-premises and/or at the edge (e.g., on a local server or computing device, but outside of the container). In such implementations, the model may be accessible via one or more APIs—such as REST APIs. As such, and in some implementations, the machine learning models described herein may be deployed as an inference microservice to accelerate deployment of models on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some implementations, the inference microservice may include software to perform in-place replacement and/or updating to the machine learning model(s). When replacing or updating, the software that performs the replacement/updating may maintain user configurations of the inference runtime software and enterprise management software.

As diarization has applications across multiple industries, the systems and methods described herein may be used for a variety of purposes, by way of example and without limitation, for machine (e.g., robot, vehicle, construction machinery, warehouse vehicles/machines, autonomous, semi-autonomous, and/or other machine types) control, machine locomotion, machine driving, synthetic data generation, model training (e.g., using real, augmented, and/or synthetic data, such as synthetic data generated using a simulation platform or system, synthetic data generation techniques such as but not limited to those described herein, etc.), perception, augmented reality (AR), virtual reality (VR), mixed reality (MR), robotics, security and surveillance (e.g., in a smart cities implementation), autonomous or semi-autonomous machine applications, deep learning, environment simulation, object or actor simulation and/or digital twinning, data center processing, conversational AI, light transport simulation (e.g., ray-tracing, path tracing, etc.), distributed or collaborative content creation for 3D assets (e.g., using universal scene descriptor (USD) data, such as OpenUSD, and/or other data types), cloud computing, generative artificial intelligence (e.g., using one or more diffusion models, transformer models, etc.), and/or any other suitable applications.

Disclosed implementations may be comprised in a variety of different systems such as automotive systems (e.g., a control system for an autonomous or semi-autonomous machine, a perception system for an autonomous or semi-autonomous machine), systems implemented using a robot or robotic platform, aerial systems, medial systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA's OMNIVERSE and/or another platform, system, or service that uses USD or OpenUSD data types), systems implemented using an edge device, systems incorporating one or more virtual machines (VMs), systems for performing synthetic data generation operations (e.g., using one or more neural rendering fields (NERFs), gaussian splat techniques, diffusion models, transformer models, etc.), systems implemented at least partially in a data center, systems for performing conversational AI operations, systems implementing one or more language models—such as one or more large language models (LLMs), one or more vision language models (VLMs), one or more multi-modal language models, etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems implemented at least partially using cloud computing resources, and/or other types of systems.

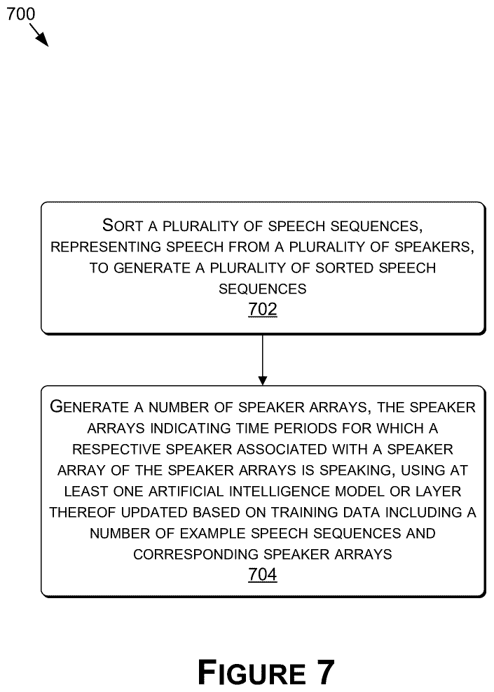

Now referring to FIGS. 7-10, each block of the methods described herein, comprise a computing process that may be performed using any combination of hardware, firmware, and/or software. For instance, various functions may be carried out using one or more processors executing instructions stored in one or more memories. The method may also be implemented as computer-usable instructions stored on computer storage media. The method may be provided by a standalone application, a service or hosted service (standalone or in combination with another hosted service), as a microservice via an application programming interface (API) or a plug-in to another product, to name a few. In addition, methods are described, by way of example, with respect to the systems of FIGS. 1-6. However, this method may additionally or alternatively be executed by any one system, or any combination of systems, including, but not limited to, those described herein.

FIG. 7 is a flow diagram showing a method 700 for diarization of audio captured speech using sorting functionality, in accordance with some implementations of the present disclosure. Method 700 can be used during the training phase (e.g., by model training manager 160, training system 200 or 201) and/or during the online phase when the model is used perform diarization. Method 700 can be carried out or executed by any of the systems or any of neural network models or model layers presented herein.

The method 700, at block 702, can include sorting a number of speech sequences to generate a number of sorted speech sequences in some implementations. The speech sequences can represent speech from a number of different speakers. For example, a speech sequence can refer to a dimension of the original input embedding or new embedding produced by a layer of a diarization model including the final diarization output either in numeric form (e.g., in the range (0, 1)) or a logical array. Sorting can be performed by ordering the speakers based on the first time slice for which a speaker is indicating as speaking (e.g., when the diarization output is 1 or when it is greater than a threshold). Sorting can also be performed by variance of a dimension of a speech embedding across all time periods (e.g., a speech sequence). Sorting can be performed by any components of the diarization system 100 configured to perform diarization; for example, the user device 120 or the data processing system 140.

Arrival time sorting can, for example, be performed by the arrival time sorter 520 as part of a sorting transformer encoder layer 500, the arrival time sort function 206 or 214 as part of the training process, or otherwise perform functionality similar to the functionality described with reference to FIG. 3. Sorting based on arrival time has various online and training advantages. Without limitation, some advantages include, lower computational demand compared to permutation invariant learning, combining outputs of multiple encoder layers for rapid training, and real-time speaker index assignment without matching the indices of previous inferences.

Sorting can also be performed by variance of a dimension across all time periods. For example, variance-based sorting can be performed in a variance-sort pooling layer 508 part of a sorting transformer encoder layer 500 or otherwise perform functionality similar to the functionality described with reference to FIG. 5B.

The method 700, at block 704, can include generating a number of speaker arrays, using one or more layers of a neural network model (e.g., the diarization model 400, a layer or sorting transformer encoder, etc.). The one or more layers of a neural network model can be updated (e.g., trained, subjected to a learning algorithm, or parameters thereof otherwise adjusted) based on training data. The training data can include a number of example speech sequences (e.g., the embedded speech) and speaker arrays corresponding to the example speech sequences and the speaker array can indicate the time periods for which a respective speaker associated with a speaker array is speaking. In some implementations, generating the speaker arrays includes executing the forward path of a diarization model (e.g., model 400 or 210) and can be performed both during live diarization and/or while training the diarization model.

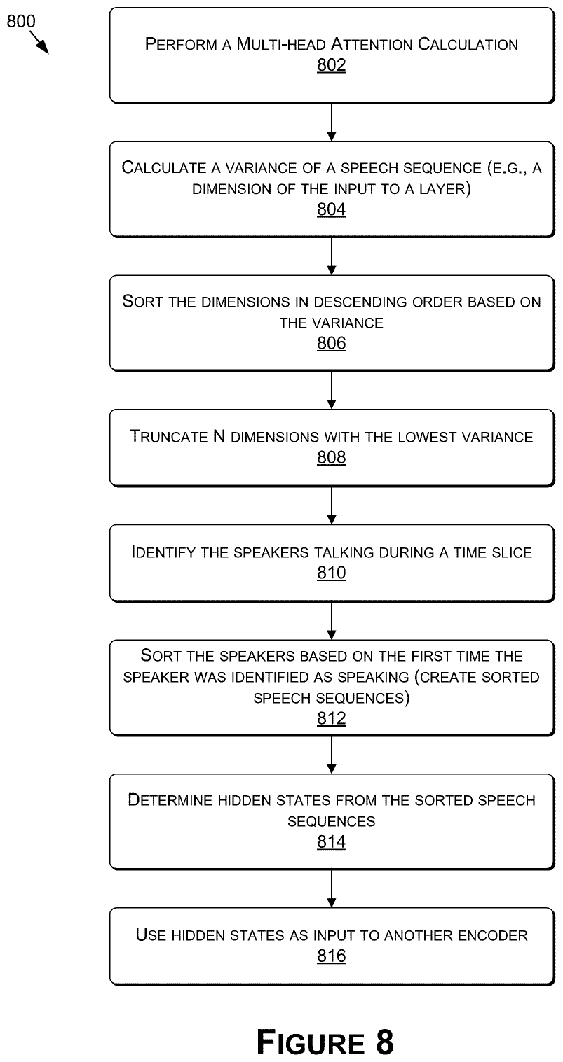

FIG. 8 is a flow diagram showing a method 800 for diarization of audio captured speech using sorting functionality, in accordance with some implementations of the present disclosure. Method 800, for example, can be performed in the evaluation of the sorting transformer encoder layer 500 potentially by the diarization system 100 (e.g., by the sorting transformer module 158 or the sorting transformer module 132) in training or during diarization.

The method 800, at block 802, can include performing a multi-head attention calculation in some implementations. Multi-head attention can allow the model to learn temporal relationships across multiple time scales without the memory elements of a long-short term memory (LSTM) model. At block 802 calculations described with reference to FIG. 5A multi-head attention layer 504 or similar calculations can be performed.

The method 800, at block 804, can include calculating a variance of a speech sequence (e.g., dimension of the input to a layer or sublayer) in some implementations. Variance calculations can be performed in the sorting transformer encoder layer 500 as implemented with the sorting transformer module 158 of the data processing system 140, for example. In some implementations, the variance of all dimensions of the input to the layer or sublayer is calculated. All time slices for a dimension of the current embedding entering the layer can be used to calculate the variance. Often the variance is a good measure of how much discrimination potential there is within a dimension. For example, dimensions with high variance can also provide information to the model as to which speaker is speaking during a time slice.

To take advantage of the discriminating information while discarding confounding information, method 800 can include sorting the dimensions in descending order based on the variance at block 806 and truncating (e.g., removing, not propagating, multiplying by a zero weight, etc.) the N dimensions with the lowest variance at block 808. N can represent a number of dimensions that should be removed and can be given as a number or as a fraction of the total number of dimensions input to the layer. In addition to potentially causing the model to focus more on the discriminating information (e.g. rather than background noise, etc.), eliminating a number of dimensions can reduce the computational complexity of both evaluating the model online and during training, ultimately increasing the efficiency of the process, lowering training time, and decreasing power dissipation by the processing circuits. In some implementations, the dimensions with lower variance (e.g., below a threshold) or lower information content (e.g., independent of the dimensions already used) can be truncated, removed, or otherwise caused to not affect the output of the sorting transformer encoder layer.

The method 800, at block 810, can include identifying the speakers talking during a time slice in some implementations. In some implementations, all time slices are processed simultaneously while propagating through the diarization model. Identifying speakers talking during the time slices can utilize the calculations of previous blocks. For example, the multi-head attention calculation (e.g., block 802) and the variance sorting (e.g., blocks 804-808) outputs can be used in identifying the speakers. Several additional calculations can be performed. Linear transformations can be performed, nonlinear activation functions (e.g., sigmoid, ReLU, etc.), normalizations, sigmoid labeling, residual connections, aggregations, positional encodings, or any other suitable calculation or model layer can be included as part of the operations of block 810.

The method 800, at block 812, can include sorting the speakers based on the first time the speaker was identified as speaking in some implementations. For example, the sorting function can be performed as described with reference to FIG. 3. Sorting can be performed by data processing system 140 (e.g., sorting transformer module 158) and/or user device 120 (e.g., sorting transformer module 132) during training or during the evaluation of diarization model 400.

In some implementations, the sorted speech sequences are output of the layer to be combined with the sorted outputs of other layers. Sorted speech sequences can also be used to determine hidden states from the sorted speech sequences at block 814. For example, the sorted speech sequences can be input through feedforward layers to determine the new embedding. In some implementations, a feedforward layer that increases the dimensionality back to that of the original input embedding is used to allow a residual connection from prior to the truncation of the dimensions with low variance. At block 816 the hidden states (or new embedding) can be used as the input (e.g., as an input embedding, a number of speech sequences, etc.) to a next encoder layer in some implementations.

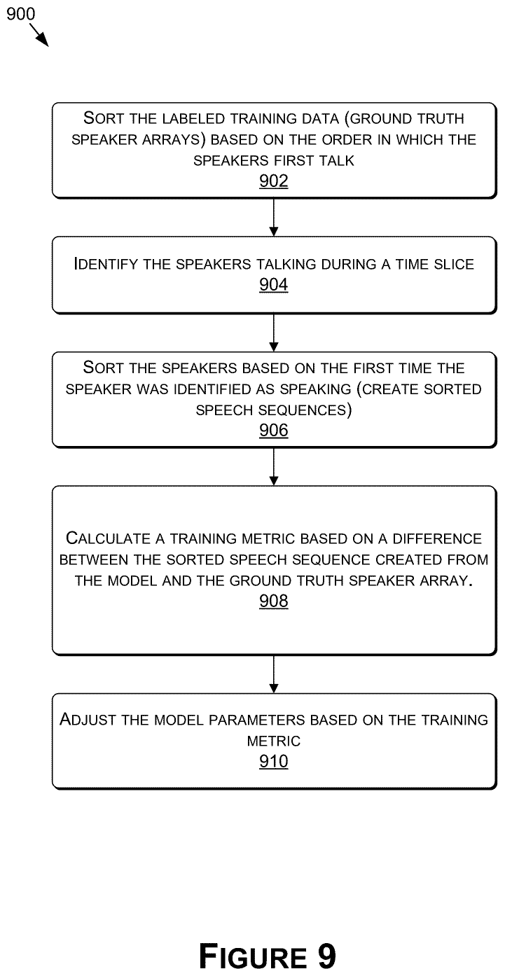

FIG. 9 is a flow diagram showing a method 900 for training a diarization model with sort functionality, in accordance with some implementations of the present disclosure. Method 900, for example, can be performed by the data processing system 140 with the model training manager 160. Functionally, method 900 can be performed by the training system 200 or 201.

The method 900, at block 902, can include sorting the labeled training data (ground truth speaker arrays) based on the order in which the speakers first talk in some implementations. The operations of block 902 prepare the ground truth to be compared with the output of the diarization model, other operations/blocks in the method are related to evaluating the current diarization model to obtain a model prediction. In some implementations, multiple permutations of the ground truth can be compared to the model prediction and the one that compares the best (e.g., lowest loss function) is used for back propagation.

The method 900, at block 904, can include identifying the speakers talking during a time slice or period in some implementations. In some implementations, all time slices will be processed simultaneously while propagating through the diarization model. The method 900 can include sorting the speakers based on the first time the speaker was identified as speaking at block 906. For example, the operations can sort the speech sequences for each speaker created by the diarization model or a component or layer thereof thus creating sorted speaker arrays. In some implementations, sorting can be performed multiple times. For example, within a layer of the diarization model (e.g., sorting transformer encoder layer 500) and/or at the end of a sequence of multiple encoder layers. Sorting the ground truth (e.g., at block 902) and the model output (e.g., at block 906) can provide a unique speaker assignment that can be compared without performing the permutations required by PIL or a similar technique. In some implementations, the operations of block 902 are not performed and instead multiple permutations of the ground truth are found and compared to the sorted speech sequences after the operations of block 906.

In some implementations, the method 900, at block 908, can include calculating a training metric based on a difference between the sorted speech sequences generated by the diarization model and a ground truth speaker array. A training metric can refer to any function of two sets of speaker arrays for which a lower evaluation implies the model is predicting the ground truth speaker array better in some implementations. For example, binary cross entropy (BCE) loss can be used as the training metric as described previously.

The method 900, at block 910, can include adjusting the current model parameters based on the training metric. For example, the gradient of the training metric with respect to each weight can be found using a back propagation technique and the weights (e.g., parameters can be adjusted in a direction that causes the training metric (e.g., the loss related to the chosen permutation of the ground truth) to be decreased.

In some implementations, method 900 can be repeated a number of times or until a different stopping criterion (e.g., loss is reaches a threshold level, loss on validation data increases, etc.) is met. Training the diarization model can be performed for a thousand passes through all of the data, for example. In some implementations, a certain amount of collected data that has been labeled with a respective ground truth (e.g., 20%) is kept aside from the training data as part of a validation data set. During training the BCE loss or other training metric can be calculated for the validation set by averaging the BCE loss of all samples or by using a different statistic of the BCE loss across samples (e.g., the average of the worst 10% of the validation data). Training can be stopped if the loss for the validation data increases; for example, for a number of consecutive passes through the training data. In some implementations, small adjustments can be made to the live model as new data is collected rather than performing a full retraining of the model.

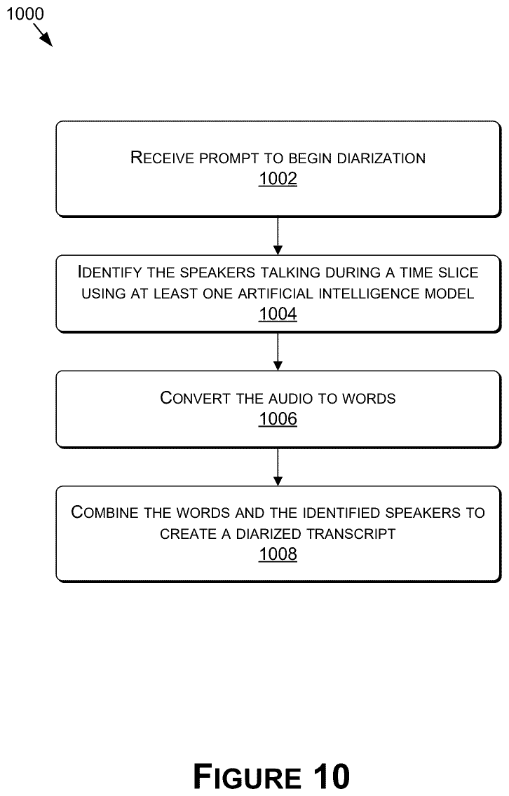

FIG. 10 is a flow diagram showing a method 1000 for performing speech recognition and diarization, in accordance with some implementations of the present disclosure. Method 1000, for example, can be performed by the data processing system 140 and/or the diarization and speech recognition system 600. The method 1000 can perform end to end speech recognition and diarization. For example, starting with a trigger to start the operations by a user and completing with a text representation of the spoken words from the audio source labeled with a speaker index that remains consistent throughout the diary for each speaker.

In some implementations, the method 1000, at block 1002 can include receiving a prompt to begin diarization and/or speech recognition. The prompt could be of many forms, including non-limiting examples of a spoken command, a button clicked on a user interface, a dedicated diarization button on specialized hardware, and/or a text typed into a chat window.

The method 1000, at block 1004, can include identifying the speakers talking during a time slice. For example, the speakers talking can be identified for all time slices of an audio source to form a set of speaker arrays. In some implementations, identifying a speaker refers to indicating that a unique speaker is talking during a time slice or indicating a speaker who has previously spoken is talking during the time slice (and if the speaker has previously spoken, identifying which of the previous speakers). Identifying a speaker can also include associating one of the speakers with a particular unique individual (e.g., by employee ID, name, etc.); however, the present disclosure is not limited to implementations where this association is performed.

In some implementations, the method 1000, at block 1006 can include converting the audio into words (e.g., text for display). Converting the audio to words or text can be performed by another artificial intelligence model (e.g., the automatic speech recognition model 606). Block 1006 can create different time slices and/or different embeddings than during the diarization operations (e.g., block 1004).

In some implementations method 1000, at block 1008, can include combining the words or text with the identified speakers to create a diarized transcript. The diarized transcript can be communicated to another device (e.g., with a monitor or display) so that it can be viewed. For example, the diarized transcript can be communicated to participating user devices (e.g., user device 110 and/or user device 120).

### Example Language Models

In at least some implementations, language models, such as large language models (LLMs), vision language models (VLMs), multi-modal language models (MMLMs), and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in implementations, based on the models being trained on massive datasets and having architectures with large number of learnable network parameters (weights and biases)—such as millions or billions of parameters. The LLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The LLMs/VLMs/MMLMs/etc. of the present disclosure may be used exclusively for text processing, in implementations, whereas in other implementations, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented to accept image, video, audio, textual, 3D design (e.g., CAD), and/or other inputs data types and/or to generate or output image, video, audio, textual, 3D design, and/or other output data types. Large language models may be used to perform automatic speech recognition and/or to interpret user commands that may begin the speaker diarization. In some implementations, portions of a large language model (e.g., the form of various layers, etc.) may be used in models for speaker diarization.

Various types of LLMs/VLMs/MMLMs/etc. architectures may be implemented in various implementations. For example, different architectures may be implemented that use different techniques for understanding and generating outputs—such as text, audio, video, image, 2D and/or 3D design or asset data, etc. In some implementations, LLMs/VLMs/MMLMs/etc. architectures such as recurrent neural networks (RNNs) or long short-term memory networks (LSTMs) may be used, while in other implementations transformer architectures—such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/VLMs/MMLMs/etc. may also include one or more diffusion block(s) (e.g., denoisers). The LLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/VLMs/MMLMs/etc. that include both encoder and decoder components like T5 (Text-to-Text Transformer) may be implemented to understand and generate content, such as for translation and summarization. These examples are not intended to be limiting, and any architecture type—including but not limited to those described herein—may be implemented depending on the particular implementation and the task(s) being performed using the LLMs/VLMs/MMLMs/etc.

In various implementations, the LLMs/VLMs/MMLMs/etc. may be trained using unsupervised learning, in which an LLMs/VLMs/MMLMs/etc. learns patterns from large amounts of unlabeled text/audio/video/image/design/USD/etc. data. Due to the extensive training, in implementations, the models may not require task-specific or domain-specific training. LLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains. LLMs may be tailored to accept inputs from speech recognition and/or diarization models.

In some implementations, the LLMs/VLMs/MMLMs/etc. of the present disclosure may be implemented using various model alignment techniques. For example, in some implementations, guardrails may be implemented to identify improper or undesired inputs (e.g., prompts) and/or outputs of the models. In doing so, the system may use the guardrails and/or other model alignment techniques to either prevent a particular undesired input from being processed using the LLMs/VLMs/MMLMs/etc., and/or preventing the output or presentation (e.g., display, audio output, etc.) of information generating using the LLMs/VLMs/MMLMs/etc. In some implementations, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some implementations, the LLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3rd party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources—such as APIs, plug-ins, and/or the like.

In some implementations, multiple language models (e.g., LLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one implementation, multiple language models e.g., language models with different architectures, language models trained on different (e.g. updated) corpuses of data may be provided with the same input query and prompt (e.g., set of constraints, conditioners, etc.). In one or more implementations, the language models may be different versions of the same foundation model. In one or more implementations, at least one language model may be instantiated as multiple agents—e.g., more than one prompt may be provided to constrain, direct, or otherwise influence a style, a content, or a character, etc., of the output provided. In one or more example, non-limiting implementations, the same language model may be asked to provide output corresponding to a different role, perspective, character, or having a different base of knowledge, etc.—as defined by a supplied prompt.

In any one of such implementations, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more implementations, the output from one language model—or version, instance, or agent—maybe be provided as input to another language model for further processing and/or validation. In one or more implementations, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more implementations, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

FIG. 11A is a block diagram of an example generative language model system 1100 suitable for use in implementing at least some implementations of the present disclosure. In the example illustrated in FIG. 11A, the generative language model system 1100 includes a retrieval augmented generation (RAG) component 1192, an input processor 1105, a tokenizer 1110, an embedding component 1120, plug-ins/APIs 1195, and a generative language model (LM) 1130 (which may include an LLM, a VLM, a multi-modal LM, etc.).

At a high level, the input processor 1105 may receive an input 1101 comprising text and/or other types of input data (e.g., audio data, video data, image data, sensor data (e.g., LiDAR, RADAR, ultrasonic, etc.), 3D design data, CAD data, universal scene descriptor (USD) data—such as OpenUSD, etc.), depending on the architecture of the generative LM 1130 (e.g., LLM/VLM/MMLM/etc.). In some implementations, the input 1101 includes plain text in the form of one or more sentences, paragraphs, and/or documents. Additionally or alternatively, the input 1101 may include numerical sequences, precomputed embeddings (e.g., word or sentence embeddings), and/or structured data (e.g., in tabular formats, JSON, or XML). In some implementations in which the generative LM 1130 is capable of processing multi-modal inputs, the input 1101 may combine text (or may omit text) with image data, audio data, video data, design data, USD data, and/or other types of input data, such as but not limited to those described herein. Taking raw input text as an example, the input processor 1105 may prepare raw input text in various ways. For example, the input processor 1105 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 1105 may remove stopwords to reduce noise and focus the generative LM 1130 on more meaningful content. The input processor 1105 may apply text normalization, for example, by converting all characters to lowercase, removing accents, and/or or handling special cases like contractions or abbreviations to ensure consistency. These are just a few examples, and other types of input processing may be applied.

In some implementations, a RAG component 1192 (which may include one or more RAG models, and/or may be performed using the generative LM 1130 itself) may be used to retrieve additional information to be used as part of the input 1101 or prompt. RAG may be used to enhance the input to the LLM/VLM/MMLM/etc. with external knowledge, so that answers to specific questions or queries or requests are more relevant—such as in a case where specific knowledge is required. The RAG component 1192 may fetch this additional information (e.g., grounding information, such as grounding text/image/video/audio/USD/CAD/etc.) from one or more external sources, which can then be fed to the LLM/VLM/MMLM/etc. along with the prompt to improve accuracy of the responses or outputs of the model.

For example, in some implementations, the input 1101 may be generated using the query or input to the model (e.g., a question, a request, etc.) in addition to data retrieved using the RAG component 1192. In some implementations, the input processor 1105 may analyze the input 1101 and communicate with the RAG component 1192 (or the RAG component 1192 may be part of the input processor 1105, in implementations) in order to identify relevant text and/or other data to provide to the generative LM 1130 as additional context or sources of information from which to identify the response, answer, or output 1190, generally. For example, where the input indicates that the user is interested in a desired tire pressure for a particular make and model of vehicle, the RAG component 1192 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 1192 may retrieve a prior stored conversation history—or at least a summary thereof—and include the prior conversation history along with the current ask/request as part of the input 1101 to the generative LM 1130.

The RAG component 1192 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 1192 and the embeddings of the chunks along with the embeddings of the query may be compared to identify the most similar/related embeddings to the query, which may be supplied to the generative LM 1130 to generate an output.

In some implementations, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/VLM/MMLM/etc. to answer using them. The knowledge graph, in such implementations, may contain relevant textual content and metadata about the knowledge graph as well as be integrated with a vector database. In some implementations, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/VLM/MMLM/etc. may summarize the results. In such an example, the graph may store relevant factual information, and a query (natural language query) to graph query tool (NL-to-Graph-query tool) and entity linking may be used. In some implementations, graph RAG (e.g., using a graph database) may be combined with standard (e.g., vector database) RAG, and/or other RAG types, to benefit from multiple approaches.

In any implementations, the RAG component 1192 may implement a plugin, API, user interface, and/or other functionality to perform RAG. For example, a graph RAG plug-in may be used by the LLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 1110 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 1130 to understand morphological variations and handle out-of-vocabulary words more effectively. Character-based tokenization represents each character as a separate token, enabling the generative LM 1130 to process text at a fine-grained level. The choice of tokenization strategy may depend on factors such as the language being processed, the task at hand, and/or characteristics of the training dataset. As such, the tokenizer 1110 may convert the (e.g., processed) text into a structured format according to tokenization schema being implemented in the particular implementation.

The embedding component 1120 may use any known embedding technique to transform discrete tokens into (e.g., dense, continuous vector) representations of semantic meaning. For example, the embedding component 1120 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 1101 includes image data/video data/etc., the input processor 1101 may resize the data to a standard size compatible with format of a corresponding input channel and/or may normalize pixel values to a common range (e.g., 0 to 1) to ensure a consistent representation, and the embedding component 1120 may encode the image data using any known technique (e.g., using one or more convolutional neural networks (CNNs) to extract visual features). In some implementations in which the input 1101 includes audio data, the input processor 1101 may resample an audio file to a consistent sampling rate for uniform processing, and the embedding component 1120 may use any known technique to extract and encode audio features—such as in the form of a spectrogram (e.g., a mel-spectrogram). In some implementations in which the input 1101 includes video data, the input processor 1101 may extract frames or apply resizing to extracted frames, and the embedding component 1120 may extract features such as optical flow embeddings or video embeddings and/or may encode temporal information or sequences of frames. In some implementations in which the input 1101 includes multi-modal data, the embedding component 1120 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 1130 and/or other components of the generative LM system 1100 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 1120 may apply an encoded representation of the input 1101 to the generative LM 1130, and the generative LM 1130 may process the encoded representation of the input 1101 to generate an output 1190, which may include responsive text and/or other types of data.

As described herein, in some implementations, the generative LM 1130 may be configured to access or use—or capable of accessing or using—plug-ins/APIs 1195 (which may include one or more plug-ins, application programming interfaces (APIs), databases, data stores, repositories, etc.). For example, for certain tasks or operations that the generative LM 1130 is not ideally suited for, the model may have instructions (e.g., as a result of training, and/or based on instructions in a given prompt, such as those retrieved using the RAG component 1192) to access one or more plug-ins/APIs 1195 (e.g., 3rd party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 1195 to the plug-in/API 1195, the plug-in/API 1195 may process the information and return an answer to the generative LM 1130, and the generative LM 1130 may use the response to generate the output 1190. This process may be repeated—e.g., recursively—for any number of iterations and using any number of plug-ins/APIs 1195 until an output 1190 that addresses each ask/question/request/process/operation/etc. from the input 1101 can be generated. As such, the model(s) may not only rely on its own knowledge from training on a large dataset(s) and/or from data retrieved using the RAG component 1192, but also on the expertise or optimized nature of one or more external resources—such as the plug-ins/APIs 1195.

FIG. 11B is a block diagram of an example implementation in which the generative LM 1130 includes a transformer encoder-decoder. For example, assume input text such as “Who discovered gravity” is tokenized (e.g., by the tokenizer 1110 of FIG. 11A) into tokens such as words, and each token is encoded (e.g., by the embedding component 1120 of FIG. 911A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 1135 of the generative LM 1130. Various speaker diarization models may also use transformer-based architectures. For example, speaker diarization may make use of an attention functionality common in transformer models. Diarization models may also use only encoder layers of the transformer model.

In an example implementation, the encoder(s) 1135 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 1140 may convert the context vector into attention vectors (keys and values) for the decoder(s) 1145.

In an example implementation, the decoder(s) 1145 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 1135, in an example transformer architecture, each token (e.g., word) flows through a separate path in the decoder(s) 1145. During a first pass, the decoder(s) 1145, a classifier 1150, and a generation mechanism 1155 may generate a first token, and the generation mechanism 1155 may apply the generated token as an input during a second pass. The process may repeat in a loop, successively generating and adding tokens (e.g., words) to the output from the preceding pass and applying the token embeddings of the composite sequence with positional encodings as an input to the decoder(s) 1145 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 1135, except that it creates its queries from the layer below it and takes the keys and values (e.g., matrix) from the output of the encoder(s) 1135.

As such, the decoder(s) 1145 may output some decoded (e.g., vector) representation of the input being applied during a particular pass. The classifier 1150 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 1155 may select or sample a word or token based on a corresponding predicted probability (e.g., select the word with the highest predicted probability) and append it to the output from a previous pass, generating each word or token sequentially. The generation mechanism 1155 may repeat the process, triggering successive decoder inputs and corresponding predictions until selecting or sampling a symbol or token that represents the end of the response, at which point, the generation mechanism 1155 may output the generated response.

FIG. 11C is a block diagram of an example implementation in which the generative LM 1130 includes a decoder-only transformer architecture. For example, the decoder(s) 1160 of FIG. 11C may operate similarly as the decoder(s) 1145 of FIG. 11B except each of the decoder(s) 1160 of FIG. 11C omits the encoder-decoder self-attention layer (since there is no encoder in this implementation). As such, the decoder(s) 1160 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 1160. As with the decoder(s) 1145 of FIG. 11B, each token (e.g., word) may flow through a separate path in the decoder(s) 1160, and the decoder(s) 1160, a classifier 1165, and a generation mechanism 1170 may use auto-regression to sequentially generate one token at a time until predicting a symbol or token that represents the end of the response. The classifier 1165 and the generation mechanism 1170 may operate similarly as the classifier 1150 and the generation mechanism 1155 of FIG. 11B, with the generation mechanism 1170 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### Example Computing Device

FIG. 12 is a block diagram of an example computing device(s) 1200 suitable for use in implementing some implementations of the present disclosure. Computing device 1200 may include an interconnect system 1202 that directly or indirectly couples the following devices: memory 1204, one or more central processing units (CPUs) 1206, one or more graphics processing units (GPUs) 1208, a communication interface 1210, input/output (I/O) ports 1212, input/output components 1214, a power supply 1216, one or more presentation components 1218 (e.g., display(s)), and one or more logic units 1220. In at least one implementation, the computing device(s) 1200 may comprise one or more virtual machines (VMs), and/or any of the components thereof may comprise virtual components (e.g., virtual hardware components). For non-limiting examples, one or more of the GPUs 1208 may comprise one or more vGPUs, one or more of the CPUs 1206 may comprise one or more vCPUs, and/or one or more of the logic units 1220 may comprise one or more virtual logic units. As such, a computing device(s) 1200 may include discrete components (e.g., a full GPU dedicated to the computing device 1200), virtual components (e.g., a portion of a GPU dedicated to the computing device 1200), or a combination thereof. Diarization system 100, training system 200 and 201, diarization and speech recognition system 600 may be implemented one or a combination of such computing devices. Similarly the methods described herein may be performed by such computing devices.

Although the various blocks of FIG. 12 are shown as connected via the interconnect system 1202 with lines, this is not intended to be limiting and is for clarity only. For example, in some implementations, a presentation component 1218, such as a display device, may be considered an I/O component 1214 (e.g., if the display is a touch screen). As another example, the CPUs 1206 and/or GPUs 1208 may include memory (e.g., the memory 1204 may be representative of a storage device in addition to the memory of the GPUs 1208, the CPUs 1206, and/or other components). As such, the computing device of FIG. 12 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 12.

The interconnect system 1202 may represent one or more links or busses, such as an address bus, a data bus, a control bus, or a combination thereof. The interconnect system 1202 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some implementations, there are direct connections between components. As an example, the CPU 1206 may be directly connected to the memory 1204. Further, the CPU 1206 may be directly connected to the GPU 1208. Where there is direct, or point-to-point connection between components, the interconnect system 1202 may include a PCIe link to carry out the connection. In these examples, a PCI bus need not be included in the computing device 1200.

The memory 1204 may include any of a variety of computer-readable media. The computer-readable media may be any available media that may be accessed by the computing device 1200. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1204 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1200. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1206 may be configured to execute at least some of the computer-readable instructions to control one or more components of the computing device 1200 to perform one or more of the methods and/or processes described herein. The CPU(s) 1206 may each include one or more cores (e.g., one, two, four, eight, twenty-eight, seventy-two, etc.) that are capable of handling a multitude of software threads simultaneously. The CPU(s) 1206 may include any type of processor, and may include different types of processors depending on the type of computing device 1200 implemented (e.g., processors with fewer cores for mobile devices and processors with more cores for servers). For example, depending on the type of computing device 1200, the processor may be an Advanced RISC Machines (ARM) processor implemented using Reduced Instruction Set Computing (RISC) or an x86 processor implemented using Complex Instruction Set Computing (CISC). The computing device 1200 may include one or more CPUs 1206 in addition to one or more microprocessors or supplementary co-processors, such as math co-processors.

In addition to or alternatively from the CPU(s) 1206, the GPU(s) 1208 may be configured to execute at least some of the computer-readable instructions to control one or more components of the computing device 1200 to perform one or more of the methods and/or processes described herein. One or more of the GPU(s) 1208 may be an integrated GPU (e.g., with one or more of the CPU(s) 1206 and/or one or more of the GPU(s) 1208 may be a discrete GPU. In implementations, one or more of the GPU(s) 1208 may be a coprocessor of one or more of the CPU(s) 1206. The GPU(s) 1208 may be used by the computing device 1200 to render graphics (e.g., 3D graphics) or perform general purpose computations. For example, the GPU(s) 1208 may be used for General-Purpose computing on GPUs (GPGPU). The GPU(s) 1208 may include hundreds or thousands of cores that are capable of handling hundreds or thousands of software threads simultaneously. The GPU(s) 1208 may generate pixel data for output images in response to rendering commands (e.g., rendering commands from the CPU(s) 1206 received via a host interface). The GPU(s) 1208 may include graphics memory, such as display memory, for storing pixel data or any other suitable data, such as GPGPU data. The display memory may be included as part of the memory 1204. The GPU(s) 1208 may include two or more GPUs operating in parallel (e.g., via a link). The link may directly connect the GPUs (e.g., using NVLINK) or may connect the GPUs through a switch (e.g., using NVSwitch). When combined together, each GPU 1208 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1206 and/or the GPU(s) 1208, the logic unit(s) 1220 may be configured to execute at least some of the computer-readable instructions to control one or more components of the computing device 1200 to perform one or more of the methods and/or processes described herein. In implementations, the CPU(s) 1206, the GPU(s) 1208, and/or the logic unit(s) 1220 may discretely or jointly perform any combination of the methods, processes and/or portions thereof. One or more of the logic units 1220 may be part of and/or integrated in one or more of the CPU(s) 1206 and/or the GPU(s) 1208 and/or one or more of the logic units 1220 may be discrete components or otherwise external to the CPU(s) 1206 and/or the GPU(s) 1208. In implementations, one or more of the logic units 1220 may be a coprocessor of one or more of the CPU(s) 1206 and/or one or more of the GPU(s) 1208.

Examples of the logic unit(s) 1220 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1210 may include one or more receivers, transmitters, and/or transceivers that allow the computing device 1200 to communicate with other computing devices via an electronic communication network, included wired and/or wireless communications. The communication interface 1210 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more implementations, logic unit(s) 1220 and/or communication interface 1210 may include one or more data processing units (DPUs) to transmit data received over a network and/or through interconnect system 1202 directly to (e.g., a memory of) one or more GPU(s) 1208.

The I/O ports 1212 may allow the computing device 1200 to be logically coupled to other devices including the I/O components 1214, the presentation component(s) 1218, and/or other components, some of which may be built in to (e.g., integrated in) the computing device 1200. Illustrative I/O components 1214 include a microphone, mouse, keyboard, joystick, game pad, game controller, satellite dish, scanner, printer, wireless device, etc. The I/O components 1214 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1200. The computing device 1200 may be include depth cameras, such as stereoscopic camera systems, infrared camera systems, RGB camera systems, touchscreen technology, and combinations of these, for gesture detection and recognition. Additionally, the computing device 1200 may include accelerometers or gyroscopes (e.g., as part of an inertia measurement unit (IMU)) that allow detection of motion. In some examples, the output of the accelerometers or gyroscopes may be used by the computing device 1200 to render immersive augmented reality or virtual reality.

The power supply 1216 may include a hard-wired power supply, a battery power supply, or a combination thereof. The power supply 1216 may provide power to the computing device 1200 to allow the components of the computing device 1200 to operate.

The presentation component(s) 1218 may include a display (e.g., a monitor, a touch screen, a television screen, a heads-up-display (HUD), other display types, or a combination thereof), speakers, and/or other presentation components. The presentation component(s) 1218 may receive data from other components (e.g., the GPU(s) 1208, the CPU(s) 1206, DPUs, etc.), and output the data (e.g., as an image, video, sound, etc.).

### Example Data Center

FIG. 13 illustrates an example data center 1300 that may be used in at least one implementations of the present disclosure. The data center 1300 may include a data center infrastructure layer 1310, a framework layer 1320, a software layer 1330, and/or an application layer 1340. Training of the diarization models may be performed in computer devices housed in a data center. For example, data processing system 140 or any component thereof may be implemented using devices in a data center.

As shown in FIG. 13, the data center infrastructure layer 1310 may include a resource orchestrator 1312, grouped computing resources 1314, and node computing resources (“node C.R.s”) 1316(1)-1316(N), where “N” represents any whole, positive integer. In at least one implementation, node C.R.s 1316(1)-1316(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some implementations, one or more node C.R.s from among node C.R.s 1316(1)-1316(N) may correspond to a server having one or more of the above-mentioned computing resources. In addition, in some implementations, the node C.R.s 1316(1)-13161(N) may include one or more virtual components, such as vGPUs, vCPUs, and/or the like, and/or one or more of the node C.R.s 1316(1)-1316(N) may correspond to a virtual machine (VM).

In at least one implementation, grouped computing resources 1314 may include separate groupings of node C.R.s 1316 housed within one or more racks (not shown), or many racks housed in data centers at various geographical locations (also not shown). Separate groupings of node C.R.s 1316 within grouped computing resources 1314 may include grouped compute, network, memory or storage resources that may be configured or allocated to support one or more workloads. In at least one implementation, several node C.R.s 1316 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1312 may configure or otherwise control one or more node C.R.s 1316(1)-1316(N) and/or grouped computing resources 1314. In at least one implementation, resource orchestrator 1312 may include a software design infrastructure (SDI) management entity for the data center 1300. The resource orchestrator 1312 may include hardware, software, or some combination thereof.

In at least one implementation, as shown in FIG. 13, framework layer 1320 may include a job scheduler 1328, a configuration manager 1334, a resource manager 1336, and/or a distributed file system 1338. The framework layer 1320 may include a framework to support software 1332 of software layer 1330 and/or one or more application(s) 1342 of application layer 1340. The software 1332 or application(s) 1342 may respectively include web-based service software or applications, such as those provided by Amazon Web Services, Google Cloud and Microsoft Azure. The framework layer 1320 may be, but is not limited to, a type of free and open-source software web application framework such as Apache Spark™ (hereinafter “Spark”) that may use distributed file system 1338 for large-scale data processing (e.g., “big data”). In at least one implementation, job scheduler 1328 may include a Spark driver to facilitate scheduling of workloads supported by various layers of data center 1300. The configuration manager 1334 may be capable of configuring different layers such as software layer 1330 and framework layer 1320 including Spark and distributed file system 1338 for supporting large-scale data processing. The resource manager 1336 may be capable of managing clustered or grouped computing resources mapped to or allocated for support of distributed file system 1338 and job scheduler 1328. In at least one implementation, clustered or grouped computing resources may include grouped computing resource 1314 at data center infrastructure layer 1310. The resource manager 1336 may coordinate with resource orchestrator 1312 to manage these mapped or allocated computing resources.

In at least one implementation, software 1332 included in software layer 1330 may include software used by at least portions of node C.R.s 1316(1)-1316(N), grouped computing resources 1314, and/or distributed file system 1338 of framework layer 1320. One or more types of software may include, but are not limited to, Internet web page search software, e-mail virus scan software, database software, and streaming video content software.

In at least one implementation, application(s) 1342 included in application layer 1340 may include one or more types of applications used by at least portions of node C.R.s 1316(1)-1316(N), grouped computing resources 1314, and/or distributed file system 1338 of framework layer 1320. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more implementations.

In at least one implementation, any of configuration manager 1334, resource manager 1336, and resource orchestrator 1312 may implement any number and type of self-modifying actions based on any amount and type of data acquired in any technically feasible fashion. Self-modifying actions may relieve a data center operator of data center 1300 from making possibly bad configuration decisions and possibly avoiding underutilized and/or poor performing portions of a data center.

The data center 1300 may include tools, services, software or other resources to train one or more machine learning models or predict or infer information using one or more machine learning models according to one or more implementations described herein. For example, a machine learning model(s) may be trained by calculating weight parameters according to a neural network architecture using software and/or computing resources described above with respect to the data center 1300. In at least one implementation, trained or deployed machine learning models corresponding to one or more neural networks may be used to infer or predict information using resources described above with respect to the data center 1300 by using weight parameters calculated through one or more training techniques, such as but not limited to those described herein. Developer device 180 may be used to access information from the data center to perform deployment of a new diarization model, to label collected audio data for training, and/or initiate training.

In at least one implementation, the data center 1300 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing implementations of the disclosure may include one or more client devices, servers, network attached storage (NAS), other backend devices, and/or other device types. The client devices, servers, and/or other device types (e.g., each device) may be implemented on one or more instances of the computing device(s) 1200 of FIG. 12—e.g., each device may include similar components, features, and/or functionality of the computing device(s) 1200. In addition, where backend devices (e.g., servers, NAS, etc.) are implemented, the backend devices may be included as part of a data center 1300, an example of which is described in more detail herein with respect to FIG. 13.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one implementation, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In implementations, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1200 described herein with respect to FIG. 12. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more processors comprising processing circuitry to:
sort a plurality of speech sequences, representing speech from a plurality of speakers, to generate a plurality of sorted speech sequences; and
output a plurality of speaker arrays using the plurality of sorted speech sequences and one or more layers of a neural network model, the plurality of speaker arrays indicating time periods for which a respective speaker associated with a speaker array of the plurality of speaker arrays is speaking,
wherein the neural network model is trained based at least on training data comprising a plurality of example speech sequences and corresponding speaker arrays.

2. The one or more processors of claim 1, wherein the plurality of speech sequences comprises intermediate speaker arrays and the processing circuitry is to sort the plurality of speech sequences based at least on at least a time period indicated first for the intermediate speaker arrays.

3. The one or more processors of claim 1, wherein:
the plurality of speech sequences comprises a plurality of dimensions of a speech embedding corresponding to the speech; and
the processing circuitry is to sort the plurality of speech sequences based at least on at least a variance of a dimension of the plurality of dimensions.

4. The one or more processors of claim 1, wherein the neural network model is trained based at least on a comparison of an estimated output generated using the one or more layers of the neural network model using example speech sequences of the training data and speaker arrays corresponding to the example speech sequences.

5. The one or more processors of claim 4, wherein the comparison comprises calculating a loss value between the estimated output and a plurality of order permutations of the speaker arrays corresponding to the example speech sequences.

6. The one or more processors of claim 1, wherein the processing circuitry is to generate the plurality of speech sequences as a sequence of embeddings of multiple dimensions corresponding to audio data that comprises the speech from the plurality of speakers.

7. The one or more processors of claim 1, wherein the one or more layers of the neural network model comprises layers to perform speech recognition of audio data from which the plurality of speech sequences is generated.

8. The one or more processors of claim 1, wherein the one or more layers of the neural network model comprises a plurality of encoders and an output function, the plurality of encoders comprising at least one encoder configured to sort the plurality of speaker arrays and provide the sorted plurality of speaker arrays directly to the output function.

9. The one or more processors of claim 1, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-model language models;
a system implementing one or more large language models (LLMs);
a system implementing one or more vision language models (VLMs);
a system for generating synthetic data;
a system for generating synthetic data using AI;
a system incorporating one or more virtual machines (VMs);
a system implemented at least partially in a data center; or
a system implemented at least partially using cloud computing resources.

10. A system comprising one or more processors to:
calculate a loss value based at least on a comparison between a sorted plurality of speaker arrays generated using one or more layers of a neural network model and speaker arrays corresponding to an example speech sequence,
wherein the sorted plurality of speaker arrays indicate time periods for which a respective speaker associated with a speaker array of the sorted plurality of speaker arrays is speaking,
wherein the sorted plurality of speaker arrays is sorted based at least on at least a time period indicated first for the speaker array of the sorted plurality of speaker arrays; and
adjust parameters of the one or more layers of the neural network model based at least on the loss value.

11. The system of claim 10, wherein the one or more processors are to calculate a variance of a speech sequence of the one or more layers of the neural network model and the speech sequence is removed from affecting speaker arrays generated by the neural network model based at least on the variance of the speech sequence.

12. The system of claim 10, wherein a plurality of loss values are calculated based at least on order permutations of the speaker arrays corresponding to the example speech sequence and adjusting the parameters is based at least on a minimum loss value of the plurality of loss values.

13. The system of claim 10, wherein the one or more layers of the neural network model comprises at least one encoder configured to sort a plurality of speaker arrays and provide the sorted plurality of speaker arrays directly to an output function.

14. The system of claim 13, wherein the providing the sorted plurality of speaker arrays directly to the output function comprises bypassing a second encoder model.

15. The system of claim 10, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-model language models;
a system implementing one or more large language models (LLMs);
a system implementing one or more vision language models (VLMs);
a system for generating synthetic data;
a system for generating synthetic data using AI;
a system incorporating one or more virtual machines (VMs);
a system implemented at least partially in a data center; or
a system implemented at least partially using cloud computing resources.

16. A method comprising:
generating, using one or more layers of a neural network model, a plurality of speaker arrays indicating time periods for which a respective speaker associated with a speaker array of the plurality of speaker arrays is speaking, the one or more layers of the neural network model trained based at least on training data comprising a plurality of example speech sequences and corresponding speaker arrays; and
sorting the plurality of speaker arrays based at least on at least a time period indicated first for the speaker array.

17. The method of claim 16, the one or more layers of the neural network model are trained based at least on a comparison of an estimated output generated by the neural network model based at least on an example speech sequence of the training data and speaker arrays corresponding to the example speech sequence.

18. The method of claim 17, wherein the comparison comprises calculating a loss value between the estimated output and a plurality of order permutations of the speaker arrays corresponding to the example speech sequence.

19. The method of claim 16, further comprising:
generating a sequence of embeddings of multiple dimensions corresponding to audio data that comprises the speech from a plurality of speakers; and
sorting the multiple dimensions of the sequence of embeddings based at least on a variance of the multiple dimensions.

20. The method of claim 16, further comprising generating the plurality of speaker arrays based at least on a plurality of streams of audio data from a plurality of source devices.
